(19) United States
(12) Patent Application Publication
(10) Pub. No.: US 2024/0397155 A1
(43) Pub. Date: Nov. 28, 2024

(54) SYSTEMS AND METHODS FOR AUTOMATIC CONTENT RECOGNITION

(71) Applicant: Comcast Cable Communications, LLC, Philadelphia, PA (US)

(72) Inventors: Anthony Braskich, Schaumburg, IL (US); Ehsan Younessian, Schaumburg, IL (US); Faisal Ishtiaq, Schaumburg, IL (US); Sivasubramaniam Renganathan, Schaumburg, IL (US); Renxiang Li, Schaumburg, IL (US)

(21) Appl. No.: 18/324,481

(22) Filed: May 26, 2023

(51) Int. Cl. H04N 21/466; G06V 20/40

(52) U.S. Cl. CPC H04N 21/4668; G06V 20/46; H04N 21/4667

(57) ABSTRACT

Methods, apparatuses, and systems are described for determining content output by a device. A target video signature of a content item output at a device may be matched to one or more reference video signatures at a server. The content item may be identified based on matching the video signatures.

### BACKGROUND

Conventional content recognition solutions use either audio or video fingerprints associated with one or more frames of a content item that are matched in a library, or database, populated with reference fingerprints associated with a plurality of content items. However, these conventional content recognition solutions involve generating fingerprints associated with one or more frames of a content item. Unfortunately, some portions of content items may contain similar content. Thus, similar fingerprints may be generated for different content items, which may cause difficulties when trying to distinguish between the different content items.

### SUMMARY

It is to be understood that both the following general description and the following detailed description are exemplary and explanatory only and are not restrictive. Methods, systems, and apparatuses systems for improved automatic content recognition are described.

A device (e.g., a network device, a user device, etc.) connected to a network may generate a video signature of a content item being output on the device. In addition, a computing device (e.g., server device, headend device, etc.) may generate and/or maintain a library of video signatures of one or more content items stored in a database. The computing device may receive the video signature from the device and compare the video signature with the video signature maintained by the computing device to determine the content item being output by the device. This information may be used to determine viewing history information associated with a user or the device, which may be further used to determine viewership statistics and/or recommend content based on the user or the device.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for determining video signatures of one or more content items;

FIG. 2 shows an example system;

FIG. 3 shows an example system;

FIG. 4 shows an example system;

FIG. 5 shows an example video signature generation process;

FIG. 6 shows an example shot change;

FIGS. 7A-7B show an example frame block descriptor generation process;

FIG. 8 shows an example color layout descriptor generation process;

FIG. 9 shows an example system;

FIG. 10 shows a flowchart of an example method;

FIG. 11 shows an example machine learning system;

FIG. 12 shows a flowchart of an example machine learning method;

FIG. 13 shows a flowchart of an example method;

FIG. 14 shows a flowchart of an example method;

FIG. 15 shows a flowchart of an example method;

FIG. 16 shows a flowchart of an example method;

FIG. 17 shows a flowchart of an example method;

FIG. 18 shows a flowchart of an example method;

FIG. 19 shows a flowchart of an example method;

FIG. 20 shows a flowchart of an example method;

FIG. 21 shows a flowchart of an example method;

FIG. 22 shows a flowchart of an example method;

FIG. 23 shows a flowchart of an example method;

FIG. 24 shows a flowchart of an example method;

FIG. 25 shows a flowchart of an example method;

FIG. 26 shows a flowchart of an example method;

FIG. 27 shows a flowchart of an example method;

FIG. 28 shows a flowchart of an example method;

FIG. 29 shows a flowchart of an example method;

FIG. 30 shows a flowchart of an example method;

FIG. 31 shows a flowchart of an example method; and

FIG. 32 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Generally, as discussed herein, the terms “content item” may refer to video/audio media content that may be output (e.g., displayed) by a media presentation device. The content item may comprise one or more frames (e.g., images), including audio content, that may be output (e.g., displayed) by a media presentation device.

Generally, as discussed herein, the term “frame” may refer to a single image or single shot of a content item.

Generally, as discussed herein, the terms “frame representation” may refer to a frame block descriptor (FBD) of a frame of a content item. The FBD may comprise resized (e.g., downsized) representation of the frame (e.g., 1920×1080 pixels to 8×8 pixels). For example, the FBD may generated based on a pixel average associated with each 8×8 area of the frame.

Generally, as discussed herein, the terms “shot change” may refer to a content transition between a first scene of a content item and a second scene of the content item. For example, the shot change may be based on a content transition of the content item from a first camera perspective in a frame of the content item to a second camera perspective in a frame of the content item.

Generally, as discussed herein, the terms “timing information” may refer to information indicative of one or more of a time duration between a first shot change and a second shot change or a number of frames between a first shot change and a second shot change.

Generally, as discussed herein, the terms “shot signature” may refer to a signature representation associated with a single frame of the content item. For example, the signature representation may comprise a color layout descriptor (CLD) of a frame of the content item. The CLD may comprise data indicative of a spatial layout of the dominant colors on a grid superimposed on a frame of a content item.

Generally, as discussed herein, the terms “video signature” may refer to a signature representation associated with an entire content item. For example, the signature representation may comprise one or more shot signatures of the content item and the timing information between each shot signature of the one or more shot signatures. Generally, as discussed herein, the terms “target video signature” may refer to video signatures that are generated by a user device (e.g., television, set top box, mobile phone, smart phone, tablet computer, laptop computer, and the like.). Generally, as discussed herein, the terms “reference video signature” may refer to video signatures that are generated by a server (e.g., a computing device located at a headend, content provider, and the like).

This detailed description may refer to a given entity performing some action. It should be understood that this language may in some cases mean that a system (e.g., a computer) owned and/or controlled by the given entity is actually performing the action.

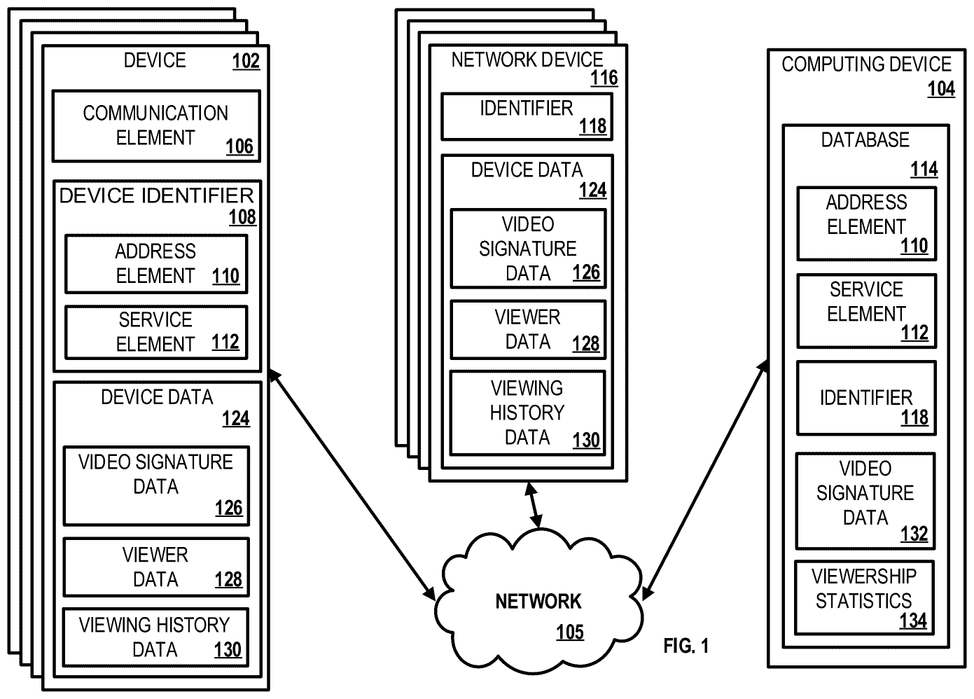

FIG. 1 shows an example system 100 for processing frames of content items. For example, the system 100 may be configured to determine a target video signature of a content item being output by a device (e.g., one or more devices 102, one or more network devices 116) and determine one or more reference video signatures of one or more content items stored in a database of a computing device (e.g., computing device 104). The system 100 may be configured to match the target video signature with a reference video signature to determine the content item output by the device. The system 100 may be configured to provide services, such as network-related services, to the device. The network and system may comprise one or more devices 102 and/or one or more network devices 116 in communication with a computing device 104, such as a server, via a network 105. The computing device 104 may be disposed locally or remotely relative to the one or more devices 102 and/or the one or more network devices 116. As an example, the one or more devices 102 and the computing device 104 may be in communication via a private and/or public network 105 such as the Internet or a local area network (LAN). Other forms of communications can be used such as wired and wireless telecommunication channels, for example.

The one or more devices 102 may comprise one or more user devices. The one or more user devices may comprise an electronic device such as a smart television, a computer, a smartphone, a laptop, a tablet, a set top box, a display device, or other device capable of communicating with the computing device 104.

The one or more devices 102 may comprise one or more communication elements 106 for providing an interface to a user to interact with the one or more devices 102 and/or the computing device 104. The communication elements 106 can be any interface for presenting and/or receiving information to/from the user, such as user feedback. An example interface may be a communication interface such as a web browser (e.g., Internet Explorer®, Mozilla Firefox®, Google Chrome®, Safari®, or the like). Other software, hardware, and/or interfaces can be used to provide communication between the user and one or more of the one or more devices 102 and the computing device 104. As an example, the communication elements 106 may request or query various files from a local source and/or a remote source. As an example, the communication elements 106 may transmit data to a local or remote device such as the computing device 104.

The one or more devices 102 may be associated with user identifiers or device identifiers 108. As an example, the device identifiers 108 may be any identifier, token, character, string, or the like, for differentiating one user or user device (e.g., the one or more devices 102) from another user or user device. In an example, the device identifiers 108 may identify a user or user device as belonging to a particular class of users or user devices. As an example, the device identifiers 108 may comprise information relating to the one or more devices 102 such as a manufacturer, a model or type of device, a service provider associated with the one or more devices 102, a state of the one or more devices 102, a locator, and/or a label or classifier. Other information can be represented by the device identifiers 108.

The device identifiers 108 may comprise address elements 110 and service elements 112. In an example, the address elements 110 can comprise or provide an internet protocol address, a network address, a media access control (MAC) address, international mobile equipment identity (IMEI) number, international portable equipment identity (IPEI) number, an Internet address, or the like. As an example, the address elements 110 can be relied upon to establish a communication session between the one or more devices 102 and the one or more network devices 116, the computing device 104, or other devices and/or networks. As an example, the address elements 110 can be used as an identifier or locator of the one or more devices 102. In an example, the address elements 110 can be persistent for a particular network.

The service elements 112 may comprise an identification of a service provider associated with the one or more devices 102, with the class of device 102, and/or with a particular network 105 with which the one or more devices 102 are currently accessing services associated with the service provider. The class of the device 102 may be related to a type of device, capability of device, type of service being provided, and/or a level of service (e.g., business class, service tier, service package, etc.). As an example, the service elements 112 may comprise information relating to or provided by a communication service provider (e.g., Internet service provider) that is providing or enabling data flow such as communication services to the one or more devices 102. As an example, the service elements 112 may comprise information relating to a preferred service provider for one or more particular services relating to the one or more devices 102. In an example, the address elements 110 may be used to identify or retrieve data from the service elements 112, or vice versa. As an example, one or more of the address elements 110 and the service elements 112 may be stored remotely from the one or more devices 102 and retrieved by one or more devices such as the one or more devices 102 and the computing device 104. Other information may be represented by the service elements 112.

One or more network devices 116 may be in communication with a network, such as the network 105. For example, the one or more network devices 116 may facilitate the connection of a device (e.g., one or more devices 102) to the network 105. As an example, the one or more network devices 116 may be configured as a set-top box, a gateway device, or wireless access point (WAP). In an example, the one or more network devices 116 may be configured to allow one or more wireless devices to connect to a wired and/or wireless network using Wi-Fi, Bluetooth®, Zigbee®, or any desired method or standard.

The one or more network devices 116 may comprise identifiers 118. As an example, the identifiers 118 may be or relate to an Internet Protocol (IP) Address (e.g., IPV4/IPV6) or a media access control address (MAC address) or the like. As an example, the identifiers 118 may be unique identifiers for facilitating communications on the physical network segment. In an example, the one or more network devices 116 may comprise distinct identifiers 118. As an example, the identifiers 118 may be associated with a physical location of the one or more network device 116.

The one or more devices 102 and the one or more network devices 116 may be configured to generate or store device data (e.g., video signature data, content viewership data, etc.). The device data 124 may include video signature data 126, viewer data 128, and viewing history data 130. For example, the one or more devices 102 and the one or more network devices 116 may be configured to generate video signature data 126 associated with one or more content items being output by the one or more devices 102 and the one or more network devices 116. For example, each content item may comprise one or more frames of the content item. One or more frame representations may be generated from the one or more frames of the content item. Each frame representation may comprise a frame block descriptor of a frame of the content item. For example, each frame representation may be generated based on a pixel average associated with each area of a plurality of areas of each frame of the content item. One or more shot changes may be determined based on the one or more frame representations. For example, each shot change may be determined based on a content transition of the content item from a first camera perspective in a frame of the content item to a second camera perspective in a frame of the content item. In an example, the content transition may be determined based on measuring a difference (e.g., numeric difference) between two adjacent frame representations. For example, a large difference between the two adjacent frame representations may be associated with a content transition of the content item from a first camera perspective in a frame of the content item to a second camera perspective in a frame of the content item. Thus, the content transition may be determined based on the difference between two adjacent frame representations satisfying a difference threshold. For example, a numerical difference that satisfies the difference threshold may indicate that a content transition has occurred, while a numerical difference that does not satisfy the difference threshold may indicate that a content transition has not occurred. Timing information may be determined based on each shot change. For example, the timing information may comprise information indicative of one or more of a time duration between a first shot change and a second shot change or a number of frames between a first shot change and a second shot change. A shot signature may be generated for each shot change of the content item. For example, one or more groups of frame representations may be determined for each shot change. A shot signature may be generated from each first frame representation of the one or more groups of frame representations. For example, each shot signature may comprise a color layout descriptor (CLD), wherein the CLD may comprise data indicative of a spatial layout of the dominant colors on a grid superimposed on a frame of the content item. For example, each shot signature may be generated based on applying a cosine transformation to each first frame representation. A video signature of a content item may be generated based on the one or more shot signatures of the content item and the timing information of the content item. In an example, one or more time intervals associated with a total length of time of the content item may be determined, wherein the one or more shot signatures may be generated based on the one or more time intervals. For example, the total length of time of the content item may be divided into multiple equal time intervals, wherein the one or more shot signatures may be generated based on the multiple time intervals. In an example, the time intervals may be determined based on a length of one or more scenes or shots of the content item or a time duration between one or more scenes or shots of the content item, wherein the shot signatures may be generated based on the determined time intervals. The video signatures may be sent to the computing device 104 to be matched against one or more video signatures stored at the computing device 104 to determine the content items output by the one or more devices 102 and the one or more network devices 116.

The one or more devices 102 and the one or more network devices 116 may receive the viewer data 128 from a viewership data provider such as a smart television content viewership data provider and associate the viewer data 128 with the video signature data 126. For example, the viewer data 128 may comprise one or more of user profile data, user attribute data, or content recommendation profile data. As content is identified, the video signature data 126 may be associated with the viewer data 128 to determine and/or update viewing history information 130. For example, the computing device 104 may identify the content items being output by the one or more devices 102 and the one or more network devices 116 and send the identified content associated with the viewer data 128 to the one or more devices 102 and the one or more network devices 116, wherein the one or more devices 102 and the one or more network devices 116 may update the viewing history information 130 based on the identified content. In an example, the video signature data 126, the viewer data 128, and the viewing history data 130 may be stored on the one or more devices 102 and/or the one or more network devices 116.

The viewing history data 130 may comprise viewership statistics associated with one or more users of the one or more devices 102 or the one or more network devices 116. For example, the viewership statistics may include information indicative of one or more of viewing durations for one or more content items or information indicative of the one or more content items output by the one or more devices 102 and the one or more network devices 116. In an example, the one or more devices 102 and/or the one or more network devices 116 may be configured to send the video signature data 126 associated with the viewer data 128 to the computing device 102. The computing device 102 may identify the content items output by the one or more devices 102 and/or the one or more network devices 116 based on the video signature data 126. In addition, the computing device 102 may associate the identification of the content items output by the one or more devices 102 and/or the one or more network devices 116 with the viewer data 128 and send data indicative of the identified content items associated with the viewer data 128 to the one or more devices 102 and/or the one or more network devices 116, wherein the one or more devices 102 and/or the one or more network devices 116 may update the viewer history data 130 based on the data. For example, the computing device 102 may determine that an episode of the “The Office” was output on a device (e.g., devices 102 or network devices 116) associated with a user profile of a particular user. The computing device 102 may send data indicative of the identified episode associated with the user profile to the user's device, wherein the user's device may update its viewer history data 130 to reflect the output of the episode of the “The Office.” In an example, the computing device 102 may send a content recommendation to the one or more devices 102 and/or the one or more network devices 116 based on the identification of the content item output on the one or more devices 102 and/or the one or more network devices 116. In an example, viewing history data 130 considered by a content recommendation profile of the one or more devices 102 and/or the one or more network devices 116 may be updated based on the identification of content output on the one or more devices 102 or the one or more network devices 116.

In an example, the one or more network devices 116 may be configured to receive the viewing history data 130 and the device identifier 108 from the one or more devices 102, wherein the one or more network devices 116 may forward the viewing history data 130 and the device identifiers 108 to the computing device 104. As an example, the one or more network devices 116 may update the viewing history information 130 based on the identification of content output by the one or more devices 102. For example, based on the identification of content output by the one or more devices 102, the one or more network devices 116 may provide a content recommendation to the one or more devices 102. In an example, the one or more network devices 116 may receive the content recommendation from the computing device 104 in response to sending the viewing history information 130, the video signature data 126, and/or the viewing history data 130 to the computing device 104. In an example, the one or more network devices 116 may update viewing history information 130 considered by a content recommendation profile based on the identification of the content being output on the one or more devices 102.

The computing device 104 may comprise a server for communicating with the one or more devices 102 and/or the one or more network devices 116. As an example, the computing device 104 may communicate with the one or more devices 102 and/or the one or more network devices 116 for providing data and/or services. As an example, the computing device 104 may provide services, such as network (e.g., Internet) connectivity, network printing, media management (e.g., media server), content services, streaming services, broadband services, or other network-related services. As an example, the computing device 104 may allow the one or more devices 102 and/or the one or more network devices 116 to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system.

The computing device 104 may be configured to manage the communication between the one or more devices 102 and/or the one or more network devices 116 and a database 114 for sending and receiving data therebetween. As an example, the database 114 may store a plurality of files (e.g., web pages), user identifiers or records (e.g., viewership statistics 134), or other information (e.g., video signature data 132). As an example, the one or more devices 102 and/or the one or more network devices 116 may request and/or retrieve a file from the database 114. In an example, the database 114 may store information relating to the one or more devices 102 and/or the one or more network devices 116 such as address elements 110, service elements 112, video signature data 132, and/or viewership statistics 134. As an example, the computing device 104 may obtain the device identifiers 108 from the one or more devices 102 and/or obtain the device identifiers 118 from the one or more network devices 116 and retrieve information from the database 114 such as the address elements 110, the service elements 112, video signature data 132, and/or viewership statistics 134. As an example, the computing device 104 may obtain the address elements 110 from the one or more devices 102 and/or the one or more network devices 116 and may retrieve the service elements 112 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

The computing device 104 may be configured to determine viewership statistics 134 for one or more devices (e.g., one or more devices 102, one or more network devices 116, etc.). For example, the computing device 104 may identify the content items output by the one or more devices and generate/update the viewership statistics 134 based the identification of the content items. For example, the computing device 104 may match video signature data 126 (e.g., target video signature data) received from the one or more devices with the video signature data 132 (e.g., reference video signature data) stored in the database 114. Based on matching the target video signature data 126 with the reference video signature data 132, the computing device 104 may determine the content items output by the one or more devices and generate/update the viewership statistics 134.

As an example, the computing device 104 may store one or more content items in the database 114. The computing device 104 may be configured to generate reference video signature data 132 associated with the one or more content items stored in the database 114. The reference video signature data 132 may be stored in the database 114. For example, each content item may comprise one or more frames of the content item. One or more frame representations may be generated from the one or more frames of the content item. Each frame representation may comprise a frame block descriptor of a frame of the content item. For example, each frame representation may be generated based on a pixel average associated with each area of a plurality of areas of each frame of the content item. One or more shot changes may be determined based on the one or more frame representations. For example, each shot change may be determined based on a content transition of the content item from a first camera perspective in a frame of the content item to a second camera perspective in a frame of the content item. Timing information may be determined based on each shot change. For example, the timing information may comprise information indicative of one or more of a time duration between a first shot change and a second shot change or a number of frames between a first shot change and a second shot change. A reference shot signature may be generated for each shot change of the content item. For example, one or more groups of frame representations may be determined for each shot change. A reference shot signature may be generated from each first frame representation of the one or more groups of frame representations. For example, each reference shot signature may comprise a CLD, wherein the CLD may comprise data indicative of a spatial layout of the dominant colors on a grid superimposed on a frame of the content item. For example, each reference shot signature may be generated based on applying a cosine transformation to each first frame representation. A reference video signature of each content item may be generated based on the one or more reference shot signatures of each content item and the timing information of each content item. In an example, one or more time intervals associated with a total length of time of each content item may be determined, wherein the one or more reference shot signatures may be generated based on the one or more time intervals. For example, the total length of time of the content item may be divided into multiple equal time intervals, wherein the one or more shot signatures may be generated based on multiple time intervals. In an example, the time intervals may be determined based on a length of one or more scenes or shots of the content item or a time duration between one or more scenes or shots of the content item, wherein the shot signatures may be generated based on the determined time intervals. The computing device 104 may receive target video signatures (e.g., video signature data 126) associated with one or more content items from the one or more devices and compare the target video signatures with the reference video signatures (e.g., video signature data 132) to determine one or more content items output by the one or more devices.

The computing device 104 may be configured to filter the video signature data 132 in the database 114 according to one or more filtering processes. As an example, the video signature data 132 may be filtered based on a frequency of occurrence associated with each reference video signature. For example, a frequency of occurrence may be determined for each reference video signature of the one or more reference video signatures associated with one or more content items. Reference video signatures may be excluded from the video signature data 132 based on the frequency of occurrence associated with the reference video signatures satisfying a threshold. The frequency of occurrence may comprise data indicative of a quantity of times a reference video signature is associated with one or more content items. In an example, the reference video signature may be determined to be a frequent video signature based on a determination that the frequency of occurrence of the reference video signature satisfies the threshold (e.g., above a threshold number of content items), and thus, excluded, or removed, from the video signature data 132. In an example, the reference video signature may be determined to be a frequent video signature if it is associated with a group of signatures, wherein the mutual distances between signatures do not satisfy a threshold. In an example, the reference video signature may be determined to be a unique video signature based on a determination that the frequency of occurrence of the reference video signature do not satisfy the threshold (e.g., below a threshold number of content items), and thus, included in the video signature data 132. For example, if a reference video signature is determined to be associated with 50 or more content items, the reference video signature may be determined to be a frequent video signature and excluded from the video signature data 132. For example, if a reference video signature is determined to be associated with less than 50 content items, the reference video signature may be determined to be a unique video signature and included in the video signature data 132. In an example, the frequency of occurrence may be indicative of a level of uniqueness associated with a video signature. For example, a low frequency of occurrence of a video signature may be indicative of a high level of uniqueness of the video signature.

As an example, the computing device 104 may be configured to associate the video signature data 132 with metadata based on the frequency of occurrence of one or more reference video signatures. For example, a reference video signature may be determined to be a frequent video signature based on a determination that the frequency of occurrence of the reference video signature is above the threshold (e.g., above a threshold number of content items), and thus, metadata may be associated with the frequent reference video signature. The metadata may comprise information indicative of one or more of a content identifier, a content type, or a content category. In addition, a target video signature associated with a content item may be received by the computing device 104, wherein the computing device 104 may be configured to associate metadata with the target video signature based on a determination that a frequency of occurrence associated with the target video signature is above the threshold. Metadata associated with a frequent target video signature may be matched with metadata associated with a frequent reference video signature to determine a content item associated with a target video signature.

As an example, the computing device 104 may be configured to associate one or more shot signatures of a video signature with metadata. The metadata may comprise information indicative of one or more of a content identifier, a content type, or a content category. A frequency of occurrence, or a level of frequency, may be determined for each shot signature. The frequency of occurrence, or the level of frequency, may comprise data indicative of a quantity of times a shot signature appears in a video signature. At least one shot signature of the one or more shot signatures may be determined as a frequent shot signature based on a frequency of occurrence of the at least one shot signature satisfying the threshold. For example, the at least one shot signature of the one or more shot signatures may be determined as a frequent shot signature based on a determination that the frequency of occurrence of the at least one shot signature is above the threshold. In an example, the at least one shot signature may be determined as a frequent shot signature based on a determination that the level of frequency of the at least one shot signature is above the threshold. The at least one shot signature may be associated with metadata based on determining that the at least one shot signature is a frequent shot signature.

As an example, the computing device 104 may be configured to identify a content item associated with a target video signature based on matching a frequent target video signature with a frequent reference video signature and based on matching a unique target video signature with a unique reference video signature. For example, the computing device 104 may be configured to receive a plurality of target video signatures associated with a plurality of content items. At least one target video signature of the plurality of target video signatures may be determined as at least one frequent target video signature and at least one target video signature may be determined as at least one unique video signature. In an example, metadata may be associated with the at least one frequent target video signature. The metadata associated with the at least one frequent target video signature may be compared with metadata associated with at least one frequent reference video signature. For example, the frequent reference video signatures may be associated with metadata and may be stored in a database (e.g., filter database) with the associated metadata. A content item associated with the at least one frequent target video signature may be determined (e.g., identified) based on matching the metadata associated with the at least one frequent target video signature with the metadata associated with the at least one frequent reference video signature. In an example, the at least one unique target video signature may be compared with at least one unique reference video signature stored in a database (e.g., reference database). A content item associated with the at least one unique target video signature may be determined (e.g., identified) based on matching the at least one unique target video signature with the at least one unique reference video signature. In an example, at least one content item of the one or more content items stored in the database 114 may be filtered out of, or removed from, the database 114 based on metadata associated with the at least one

As an example, the computing device 104 may be configured to filter the video signature data 132 in the database 114 based on a machine learning algorithm. For example, a plurality of video signatures associated with a plurality of content items may be determined. Each video signature of the plurality of video signatures may be labeled according to a video signature frequency of occurrence. The video signature frequency of occurrence may be associated with a quantity of times a video signature is associated with one or more content items. A plurality of features for a predictive model (e.g., machine learning model/algorithm) may be determined based on the plurality of video signatures. The plurality of features may comprise a plurality of frequencies of occurrence associated with the plurality of video signatures. The predictive model may be trained according to the plurality of features based on a first portion of the plurality of video signatures. As an example, training the predictive model based on the first portion of the plurality of video signatures may result in determining a feature signature indicative of at least one predetermined video signature frequency of occurrence of a plurality of video signature frequencies of occurrence. The predictive model may be tested based on a second portion of the plurality of video signatures. The predictive model may be output based on the testing. The predictive model may be configured to output a prediction indicative of a frequency of occurrence associated with a video signature.

As an example, the plurality of video signatures associated with the plurality of content items may be determined based on baseline feature levels associated with a plurality of groups of video signatures. For example, baseline feature levels for each group of video signatures of the plurality of video signatures may be determined. The baseline feature levels for each group of video signatures may be labeled as at least one predetermined video signature frequency of occurrence of a plurality of predetermined video signature frequencies of occurrence. The plurality of video signatures may be determined (e.g., generated) based on the labeled baseline feature levels.

As an example, the plurality of features for the predictive model may be determined based on a set of candidate video signatures. For example, features that are present in a group of video signatures of the plurality of video signatures may be determined, from the plurality of video signatures, as a first set of candidate video signatures. Features of the first set of candidate video signatures that satisfy a first threshold value may be determined, from the plurality of video signatures, as a second set of candidate video signatures. Features of the second set of candidate video signatures that satisfy a second threshold value may be determined, from the plurality of video signatures, as a third set of candidate video signatures. The plurality of features may comprise the third set of candidate video signatures.

In an example, a feature score for each video signature of the plurality of video signatures may be determined for the third set of candidate video signatures. A fourth set of candidate video signatures may be determined based on the feature score. The plurality of features may comprise the fourth set of candidate video signatures.

The computing device 104 may be configured to determine a plurality of frequencies of occurrence associated with the video signature data 132 (e.g., plurality of video signatures) in the database 114 based on the trained predictive model (e.g., machine learning model/algorithm). For example, as new content items become available new video signatures may be generated for the new content items. The new video signatures may be provided to the trained predictive model, wherein the trained predictive model may be configured to determine (e.g., predict) new frequencies of occurrence associated with the new video signatures. Based on the determined (e.g., predicted) frequencies of occurrence associated with the new video signatures, at least one frequent video signature and at least one unique video signature may be determined. In an example, metadata may be associated with the at least one frequent video signature. The metadata associated with the at least one frequent video signature may be compared with metadata associated with at least one frequent target video signature received from a user device. For example, a target video signature generated by a user device may also be determined as a frequent target video signature, and thus, may be associated with metadata and output to the computing device 104. A content item associated with the frequent target video signature may be determined (e.g., identified) based on matching the metadata associated with the frequent target video signature with the metadata associated with the at least one frequent video signature. In an example, the at least one unique video signature may be compared with at least one unique target video signature received from a user device. A content item associated with the unique target video signature may be determined (e.g., identified) based on matching the unique target video signature with the at least one unique video signature. In an example, a combination of the at least one frequent video signature and the at least one unique video signature may be used to determine a content item associated with a unique target video signature and/or a frequent target video signature received from a user device. For example, the computing device 104 may match the metadata associated with the at least one frequent video signature with metadata associated with the frequent target video signature. The computing device 104 may then retrieve any video signatures that may be associated with the matched metadata and use the retrieved video signatures to compare with the frequent target video signature in order to determine the content item associated with the frequent target video signature.

The computing device may 104 may be configured to determine viewership statistics 134 for the one or more devices (e.g., one or more devices 102, one or more network devices 116, etc.) based on matching the target video signatures with the reference video signatures. For example, the computing device 104 may be configured to receive the video signature data 126 along with the device identifiers 108 associated with the one or more devices and aggregate/organize the viewership statistics 134 according to user profile data from various user devices or locations. For example, the computing device 104 may update the viewership statistics 134 based on the identification of content being output by the one or more devices. For example, based on the identification of content output on the one or more devices, the computing device 104 may provide a content recommendation to the one or more devices. As an example, the computing device 104 may send the viewership statistics 134 associated with each device of the one or more devices to each device, wherein each device may update the viewing history information 130 considered by a content recommendation profile based on the identification of the content output on each device.

As an example, the viewership statistics 134 may further comprise viewer data 128 and/or viewing history data 130. For example, the one or more devices 102 and/or the one or more network devices 116 may send the viewer data 128 and/or the viewing history data 130 to the computing device 104 to be stored in the database 114 as the viewership statistic 134 data. In an example, the computing device 104 may receive the viewing history data 130 along with a device identifier 108/118 of the device 102 or network device 116, wherein the device identifier 108/118 is associated with the viewing history data 130, and store the viewing history data 130 according to the device identifier 108/118. The viewer data 128 may comprise one or more of user profile data, user attribute data, or content recommendation profile data associated with the one or more devices 102 and/or the one or more network devices 116. As content is identified, the computing device 104 may update the viewership statistics 134. In an example, based on the identification of the content item being output on the device 102 and/or the network device 116, the computing device 104 may provide a content recommendation to the device 102 and/or the network device 116. As an example, the computing device 104 may update viewing history information considered by a content recommendation profile based on the identification of the content item being output on the device 102 and/or the network device 116.

In an example, the computing device 104 may be configured to adjust a match threshold used for comparing the target video signatures to the reference video signatures in order to determine the content items associated with the target video signatures. For example, the computing device 104 may be configured to determine an indication of a quality metric associated with a target video signature. In an example, the reference video signatures of the video signature data 132 may be stored in the database 114 associated with indications of quality metrics associated with the reference video signatures. The quality metrics may comprise one or more of an aspect ratio, a resolution, or a frame rate. A quality metric associated with a target video signature may be determined to be different than a quality metric associated with the reference video signature. Based on the difference, the match threshold may be adjusted. For example, content items output by a user device (e.g., device 102, network device 116, etc.) may be associated with a different content quality (e.g., aspect ratio, resolution, frame rate, etc.) than the content items stored at the database 114. For example, standard definition content may have been used to generate the target video signatures while high definition content may have been used to generate the reference video signatures. Thus, there may be slight differences between the target video signatures from the user devices (e.g., device 102, network device 116, etc.) and the reference video signatures stored in the database 114. A match threshold (e.g., an adjustable tolerance) may be used to determine how closely a target video signature needs to match a reference video signature in order to determine the content item associated with the target video signature. For example, if a difference between a target video signature and a reference video signature satisfies the match threshold, the computing device 104 may determine that the target video signature matches the reference video signature. Thus, the content item associated with the reference video signature may be used to determine that the target video signature is associated with the content item.

In an example, the computing device 104 may be configured to adjust the match threshold based on one or more device parameters associated with a user device (e.g., device 102, network device 116, etc.). The one or more device parameters may comprise one or more of network conditions or device capabilities. For example, network bandwidth conditions or device capabilities may affect the quality of the content item output by the user device. In an example, as a result of low network bandwidth conditions, a standard definition version of the content item may be processed in order to generate the target video signature. In an example, the user device may only be capable of processing a low resolution, or a low frame rate, version of the content resulting in the target video signature being generated from a low quality content item. Thus, the match threshold may be adjusted based on the one or more device parameters in order to determine how closely a target video signature needs to match a reference video signature to determine the content item associated with the target video signature.

In an example, the match threshold may be used to determine how closely one or more shot signatures of a target video signature needs to match one or more shot signatures of a reference video signature in order to determine the content item associated with the target video signature. For example, one or more shot signatures of a target video signature may have only slight differences with one or more shot signatures of a reference video signature. In addition, the time durations of the target video signature and the time durations of the reference video signatures may match each other. The computing device 104 may determine that the slight differences between the one or more shot signatures may be within the match threshold, and thus, determine that the target video signature matches the reference video signature, especially since the time durations of the target video signature and the reference video signature match each other, for example.

In an example, the match threshold may be used to determine how closely timing information of a target video signature needs to match timing information of a reference video signature in order to determine the content item associated with the target video signature. For example, one or more time durations of a target video signature may only differ by one second in comparison to one or more time durations of a reference video signature. In addition, the shot signatures of the target video signature and the shot signatures of the reference video signature may match each other. For example, the match threshold may comprise a timing offset (e.g., timing tolerance), wherein the timing offset may comprise a tolerance of a threshold amount of time, such as a threshold of plus or minus three seconds. Since the one or more time durations of the target video signatures would be within the match threshold, the computing device 104 may determine that the target video signature matches the reference video signature, especially since the shot signatures of the target video signature and the reference video signature match each other, for example.

The devices (e.g., devices 102, network devices 116, the computing device 104, etc.) may be configured to determine an optimum number of shot signatures to use for generating the video signatures. For example, single shot signature matching might not work if there are many different programs sharing the same shot signatures, or different shot signatures with the same video signature. For example, movies produced by the same company may start with the same component introduction scene/segment. Thus, increasing the number of shot signatures used to a video signature may increase the uniqueness of the video signature. However, using too many shot signatures to generate the video signature may increase the latency, or time it takes, to generate the video signature. In addition, using too many shot signatures to generate the video signature may also risk including two different types of contents, such as a program and an advertisement, into a video signature.

As an example, an optimum number of shot signatures used to generate a video signature may be determined based on content type of a content item used to generate the video signature. For example, several movies may start with the same introduction. By using multiple shot signatures to generate the video signature, the video signature should comprise at least one shot signature unique to the movie. The devices (e.g., devices 102, network devices 116, the computing device 104, etc.) may be configured to determine a content type of a content item. For example, the content type may comprise one or more of an advertisement, a movie, linear content item, a video on demand, or a multi-episode television program. A quantity of shot signatures may be determined based on the content type. In an example, the quantity of shot signatures may comprise a quantity of frequent shot signatures and a quantity of unique shot signatures. The quantity of frequent shot signatures and the quantity of unique shot signatures may be based on a frequency of occurrence associated with the quantity of shot signatures, or one or more shot signatures. The frequency of occurrence may comprise a quantity of times each shot signature of the quantity of shot signatures appears in the content item or appears in one or more content items associated with the content type. A plurality of shot signatures may be generated based on the quantity of shot signatures. For example, the plurality of shot signatures may be generated based on the quantity of frequent shot signatures and the quantity of unique shot signatures. The video signature may be generated based on the plurality of shot signatures and timing information associated with the plurality of shot signatures.

As an example, an optimum number of shot signatures used to generate a video signature may be determined based on a uniqueness of the shot signatures that may be used to generate the video signature. For example, one or more content items may share similar scenes (e.g., frames, shots, etc.), wherein one or more of the content items may share the same shot signatures generated from the similar scenes. By including at least one unique shot signature in each video signature associated with each content item, each video signature should comprise at least one shot signature unique to the content item. The devices (e.g., devices 102, network devices 116, the computing device 104, etc.) may be configured to determine (e.g., receive, generate, etc.) a plurality of shot signatures associated with a content item. One or more shot signatures of the plurality of signatures and timing information associated with the one or more shot signatures may be determined based on information associated with each shot signature of the plurality of shot signatures. For example, the information associated with each shot signature may comprise information indicative of a measure of uniqueness of each shot signature. For example, the information associated with each shot signature may comprise metadata. The metadata may comprise information indicative of one or more of a content identifier, a content type, or a content category. In an example, the information associated with each shot signature may be determined based on a frequency of occurrence associated with each shot signature, wherein the frequency of occurrence associated with each shot signature may comprise a quantity of times each shot signature is associated with the content item. The video signature may be generated based on the one or more shot signatures and the timing information.

As an example, an optimum number of shot signatures used to generate a video signature may be determined based on a determination that a length of time associated with a shot signature is greater than a threshold (e.g., threshold time duration/length). For example, videos with only one long shot (e.g., a short advertisement/commercial) may only result in the generation of one shot signature which can lead to inaccurate identifications of the content items. If a shot is longer than a threshold time duration/length (e.g., 10 seconds), the content item may be broken down into multiple smaller time intervals (e.g., two-second intervals), wherein the shot signatures may be generated based on the smaller time intervals. The content item may be detected with longer shots sooner because the latency for generating the video signature is decreased. The devices (e.g., devices 102, network devices 116, the computing device 104, etc.) may be configured to determine a first shot signature based on a shot change associated a content item. For example, a first shot/frame of the content item may be used to generate the first shot signature. One or more second shot signatures associated with one or more time intervals of the content item may be generated based on a failure to detect a shot change with in a time duration. The time intervals may be subsequent to a time interval associated with the first shot signature, or the time duration. For example, if a shot is longer than 10 seconds, smaller time intervals, such as two-second time intervals, may be used to generate the one or more second shot signatures. For example, each shot signature of the one or more shot signatures may be generated for each two-second time interval. The video signature may be generated based on the first shot signature and the one or more second shot signatures. In an example, the video signature may further comprise the timing information indicative of the one or more time intervals. In an example, a frame representation may be generated for each frame of the content item, wherein the failure to detect the shot change may be based on failing to detect a shot change from the one or more frame representations.

As an example, an optimum number of shot signatures used to generate a video signature may be determined based on a time duration/length of the content item. For example, videos with only one long shot (e.g., a short advertisement/commercial) may only result in the generation of one shot signature which can lead to inaccurate identifications of the content items. In an example, one or more time intervals of a content item may be determined from the total time duration/length of the content item. For example, a 30-second advertisement may be split into 10 three-second intervals. By generating a shot signature for each three-second interval, the chances of a video signature having at least one shot signature unique to the content item should increase. The devices (e.g., devices 102, network devices 116, the computing device 104, etc.) may be configured to determine a time duration of a content item. One or more time intervals of the content item may be determined based on the time duration. One or more shot signatures of the content item may be generated based on the one or more time intervals. The video signature may be generated based on the one or more shot signatures. In an example, the video signature may further comprise timing information indicative of the one or more time intervals.

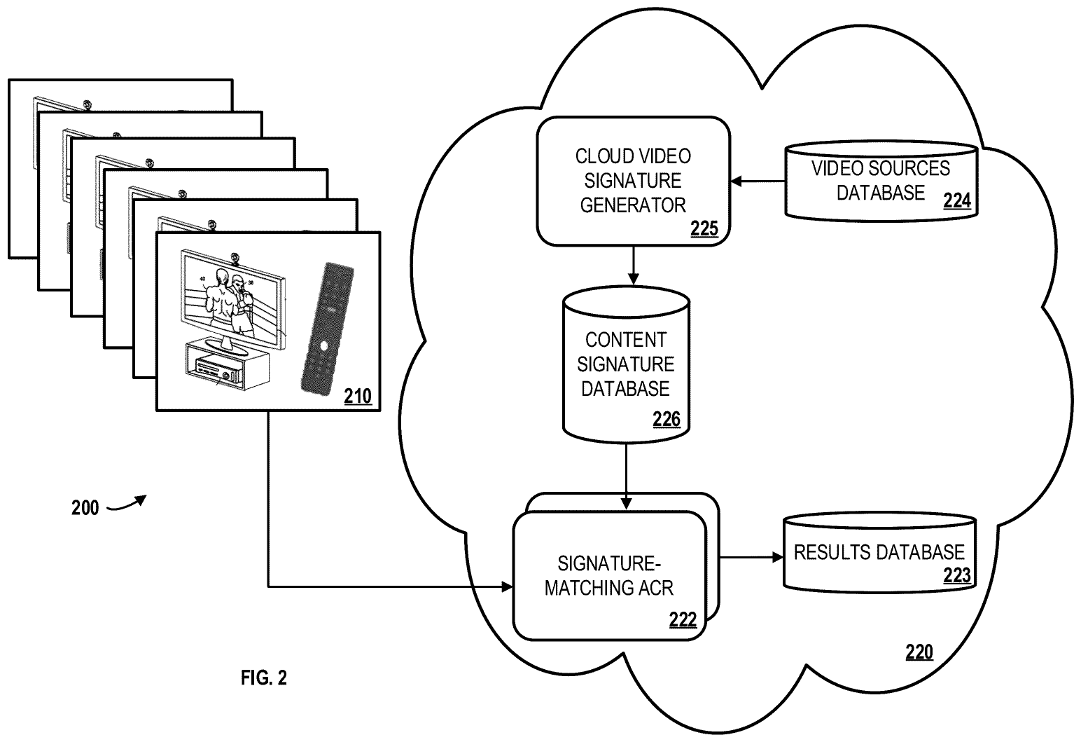

FIG. 2 shows an example system for processing target video signatures, received from one or more user devices 210 (e.g., smart television, smartphone, laptop, set top box, tablet, etc.), and reference video signatures, stored at a database 226 of a computing device 220 (e.g., server, headend, cloud computing device, etc.). For example, the computing device 220 may comprise a signature-matching automatic content recognition (ACR) device 222, a results database 223, a video source database 224, a cloud video signature generator 225, and a content signature database 226. For example, a user device 210 may output a content item. The user device 210 may generate a target video signature associated with the content item and send the target video signature to the signature-matching ACR device 222. The signature-matching ACR device 222 may match the target video signature received from the user device 210 with a reference video signature stored at the content signature database 226 to identify the content output at the user device 210. For example, the computing device 220 may receive one or more content items from one or more video source databases 224 and generate one or more video signatures via the cloud video signature generator 225. The cloud video signature generator 225 may send the reference video signatures to the content signature database 226.

The content signature database 226 may be configured to filter the reference video signatures stored in the content signature database 226 based on one or more filtering processes. For example, a frequency of occurrence may be determined for each reference video signature stored in the content signature database 226. The frequency of occurrence may comprise data indicative of a quantity of times a reference video signature is associated with one or more content items. Reference video signatures with a high frequency of occurrence may be excluded, or removed, from the content signature database 226. For example, if a reference video signature has a frequency of occurrence above a threshold (e.g., above a threshold number of content items), the reference video signature may be considered a frequent video signature, and thus, excluded, or removed, from the content signature database 226. For example, if a reference video signature has a frequency of occurrence below a threshold (e.g., below a threshold number of content items), the reference video signature may be considered a unique video signature, and thus, kept in the content signature database 226.

In an example, metadata may be associated with the frequent video signatures. For example, if a reference video signature has a frequency of occurrence above the threshold, the reference video signature may be associated with metadata. The metadata may comprise information indicative of one or more of a content identifier, a content type, or a content category. For example, the signature matching ACR 222 may match the frequent video signatures with the target video signatures received from the user devices 210, wherein the metadata associated with the frequent video signatures may be used to determine content items associated with the target video signatures received from the user devices 210.

The signature-matching ACR 222 may be configured to match the target video signatures received from the user devices 210 with the reference video signatures received from the content signature database 222. In an example, the target video signatures may be matched with the reference video signatures that have not been excluded from the content signature database 222. In an example, one or more of the target signatures received from the user devices 210 may be determined to be frequent target video signatures and one or more of the target video signatures may be determined to be unique target video signatures. The signature-matching ACR 222 may be configured to compare and match the frequent target video signatures and the frequent reference video signatures and compare and match the unique target video signatures and the unique reference video signatures. In an example, the metadata associated with the frequent reference video signatures may be used to determine one or more content items associated with the frequent target video signatures that are matched with one or more of the frequent reference video signatures.

In an example, the signature-matching ACR 222 may be configured to adjust a match threshold used for comparing the target video signatures to the reference video signatures in order to determine the content items associated with the target video signatures. For example, the signature-matching ACR 222 may be configured to determine an indication of a quality metric associated with a target video signature. In an example, the reference video signatures may be stored in the video sources database 224 associated with indications of quality metrics associated with the reference video signatures. The quality metrics may comprise data indicative of one or more of an aspect ratio, a resolution, or a frame rate. A quality metric associated with a target video signature may be determined to be different than a quality metric associated with the reference video signature. Based on the difference, the match threshold may be adjusted. For example, content items output by the user devices 210 may be associated with a different content quality (e.g., aspect ratio, resolution, frame rate, etc.) than the content items stored at the video sources database 224. For example, standard definition content may have been used to generate the target video signatures while high definition content may have been used to generate the reference video signatures. Thus, there may be slight differences between the target video signatures from the user devices 210 and the reference video signatures stored in the video sources database 224. A match threshold (e.g., an adjustable tolerance) may be used to determine how closely a target video signature needs to match a reference video signature in order to determine the content item associated with the target video signature. For example, if a difference between a target video signature and a reference video signature satisfies the match threshold, the signature-matching ACR 222 may determine that the target video signature matches the reference video signature. Thus, the content item associated with the reference video signature may be used to determine that the target video signature is associated with the content item.

In an example, the signature-matching ACR 222 may be configured to adjust the match threshold based on one or more device parameters associated with a user device 210. The one or more device parameters may comprise one or more of network conditions or device capabilities. For example, network bandwidth conditions or device capabilities may affect the quality of the content item output by the user device 210. In an example, as a result of low network bandwidth conditions, a standard definition version of the content item may be processed in order to generate the target video signature. In an example, the user device may only be capable of processing a low resolution, or a low frame rate, version of the content item resulting in the target video signature being generated from a low quality content item. Thus, the match threshold may be adjusted based on the one or more device parameters in order to determine how closely a target video signature needs to match a reference video signature to determine the content item associated with the target video signature.

In an example, the match threshold may be used to determine how closely one or more shot signatures of a target video signature needs to match one or more shot signatures of a reference video signature in order to determine the content item associated with the target video signature or how closely timing information of a target video signature needs to match timing information of a reference video signature in order to determine the content item associated with the target video signature. For example, the signature-matching ACR 222 may determine that slight differences between one or more shot signatures of a target video signature and one or more shot signatures of a reference video signature may be within the match threshold, and thus, determine that the target video signature matches the reference video signature. For example, if a difference between one or more time durations of a target video signature and one or more time durations of a reference video signature is within the match threshold, the signature-matching ACR 222 may determine that the target video signature and the reference video signature match each other.

The results of matching the target video signatures with the reference video signatures at the signature-matching ACR 222 may be sent to the results database 223. As an example, the computing device 220 may generate/update viewing history information based on identifying the content items output at the user device 210. As an example, the computing device 220 may send viewing history information associated with the user device 210 to the user device 210, wherein the user device 210 may update the viewing history information associated with the user device 210. As an example, the computing device 220 may provide a content recommendation to the user device 210 based on the viewing history associated with the user device 210. As an example, the computing device 220 may update viewing history information considered by a content recommendation profile of the user device 210 based on identifying the content item output at the user device 210.

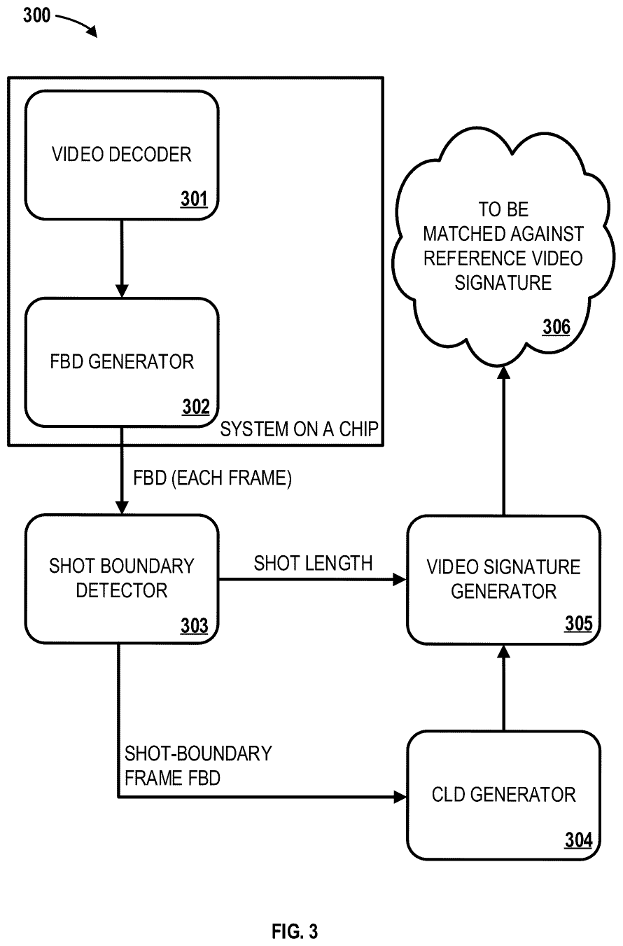

FIG. 3 shows an example system 300 for generating target video signatures output by a user device (e.g., smart television, smartphone, laptop, set top box, tablet, etc.). For example, the user device 300 may comprise a video decoder 301, a frame block descriptor (FBD) generator 302, a shot boundary detector 303, a color layout descriptor (CLD) generator 304, and a video signature generator 305. In an example, the video decoder 301 and the FBD generator 302 may be included within a system on a chip of the user device 300. The user device 300 may determine/receive a content item comprising one or more frames at a video decoder 301. The video decoder 301 may send the one or more frames of the content item to the FBD generator 302. The FBD generator 302 may generate one or more frame representations based on the one or more frames, wherein each frame representation comprises a FBD. For example, each frame representation may be generated based a pixel average associated with each area of a plurality of areas of each frame of the content item. The FBD generator 302 may resize the frame by downsizing the original frame (e.g., 1920×1080 pixels to 8×8 pixels) and send the one or more frame representations to the shot boundary detector 303. In an example, the FBD generator 302 may generate a frame representation associated with every other frame of a content item, or associated with every n^{th} (e.g., 3^{rd}, 4^{th}, 5^{th}, etc.) frame of the content item.

The shot boundary detector 303 may determine one or more shot changes of the content item. For example, the shot changes may be based on the one or more frame representations. Each shot change may be determined based on a content transition of the content item from a first camera perspective in a frame of the content item to a second camera perspective in a frame of the content item. Based on the one or more shot changes, the shot boundary detector 303 may determine timing information associated with each shot change. For example, the timing information may comprise information indicative of one or more of a time duration between a first shot change and a second shot change or a number of frames between a first shot change and a second shot change. The shot boundary detector 303 may also determine one or more groups of frame representations associated with the timing information. In an example, a time interval associated with a total length of time of the content item may be determined, wherein the one or more groups of frame representations may be determined based on the time interval. The shot boundary detector 303 may send a first frame representation of each group of frame representations to a CLD generator 304. In addition, the shot boundary detector 303 may send the timing information to a video signature generator 305. The CLD generator 304 may generate one or more target shot signatures based on one or more frame representations of each group of frame representations. For example, each target shot signature may comprise a color layout descriptor (CLD), wherein the CLD may comprise data indicative of a spatial layout of the dominant colors on a grid superimposed on a frame of the content item. For example, each target shot signature may be generated based on applying a cosine transformation to each first frame representation.

In an example, the video signature generator 305 may generate a target video signature of the content item based on the one or more shot signatures and the timing information. In an example, the video signature generator 305 may be configured to determine an optimum number of shot signatures to use for generating the video signatures. For example, single shot signature matching might not work if there are many different programs sharing the same shot signatures or different shot signatures with the same video signature. For example, movies produced by the same company may start with the same component intro. Thus, increasing the number of shot signatures used to generate a video signature may increase the uniqueness of the video signature. However, using too many shot signatures to generate the video signature may increase the latency, or time it takes, to generate the video signature. As an example, an optimum number of shot signatures used to generate a video signature may be determined based on content type of a content item used to generate the video signature, a uniqueness of the shot signatures that may be used to generate the video signature, a determination that a length of time associated with a shot signature is greater than a threshold (e.g., threshold time duration/length), or a time duration/length of the content item.

The video signature generator 305 may send the target video signature of the content item to a computing device 306 (e.g., server, cloud computing, headend, etc.) to be matched against a reference video signature stored at the computing device 306. The content item may be identified based on matching the target reference video signature to the reference video signature. As an example, viewing history information may be generated/updated based on the identification of the content item. As an example, a content recommendation may be provided to the user device 300 based on the identification of the content item. As an example, viewing history information considered by a content recommendation profile of the user device 300 may be updated based on the identification of the content item.

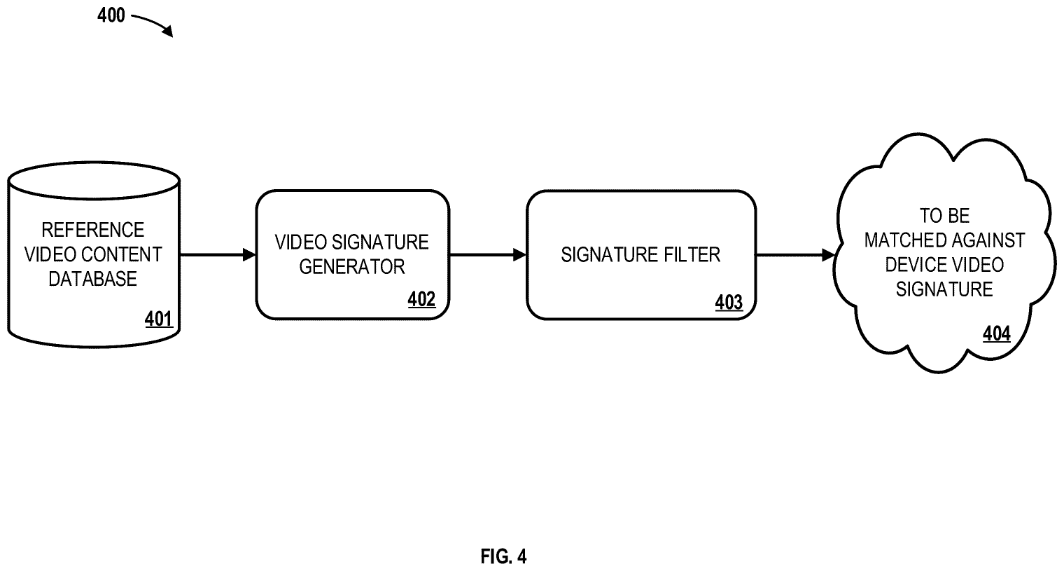

FIG. 4 shows an example system 400 for generating reference video signatures performed by a computing device (e.g., server, headend, cloud computing device, etc.). For example, the computing device 400 may comprise a reference video signature database 401, a video signature generator 402, and a signature filter 403. The computing device 400 may determine/receive one or more content items from the reference video content database 401. The reference video content database 401 may send the one or more content items to the video signature generator 402. In an example, the video signature generator 402 may perform steps similar to the steps performed by the FBD generator 302, the shot boundary detector 303, the CLD generator 304, and the video signature generator 305 shown in FIG. 3. For example, the video signature generator 402 may be configured to generate one or more frame representations based on one or more frames of the one or more content items received from the video content database 401, wherein each frame representation comprises a FBD. For example, each frame representation may be generated based on a pixel average associated with each area of a plurality of areas of each frame of each content item. One or more shot changes may be determined based on the one or more frame representations. For example, each shot change may be determined based on a content transition of a content item from a first camera perspective in a frame of the content item to a second camera perspective in a frame of the content item. Timing information may be determined based on each shot change. For example, the timing information may comprise information indicative of one or more of a time duration between a first shot change and a second shot change or a number of frames between a first shot change and a second shot change. A reference shot signature may be generated for each shot change of each content item. For example, one or more groups of frame representations may be determined for each shot change. A reference shot signature may be generated from each first frame representation of the one or more groups of frame representations. For example, each reference shot signature may comprise a color layout descriptor. For example, each reference shot signature may be generated based on applying a cosine transformation to each first frame representation. A reference video signature of each content item may be generated based on the one or more reference shot signatures of each content item and the timing information of each content item. In an example, a time interval associated with a total length of time of each content item may be determined, wherein the one or more reference shot signatures may be generated based on the time interval.

In an example, the signature generator 402 may be configured to determine an optimum number of shot signatures to use for generating the reference video signatures. For example, single shot signature matching might not work if there are many different programs sharing the same shot signatures or different shot signatures with the same video signature. For example, movies produced by the same company may start with the same component intro. Thus, increasing the number of shot signatures used to a video signature may increase the uniqueness of the video signature. However, using too many shot signatures to generate the video signature may increase the latency, or time it takes, to generate the video signature. As an example, an optimum number of shot signatures used to generate a video signature may be determined based on content type of a content item used to generate the video signature, a uniqueness of the shot signatures that may be used to generate the video signature, a determination that a length of time associated with a shot signature is greater than a threshold (e.g., threshold time duration/length), or a time duration/length of the content item.

The video signature generator 402 may send the one or more reference video signatures of the one or more content items to the signature filter 403. The signature filter 403 may be configured to filter the one or more reference video signatures received from the video signature generator 402 based on one or more filtering processes. For example, a frequency of occurrence may be determined for each reference video signature received from the video signature generator 402. The frequency of occurrence may comprise data indicative of a quantity of times a reference video signature is associated with one or more content items. Reference video signatures with a high frequency of occurrence may be excluded, or removed, from the reference video signatures received from the video signature generator 402. For example, if a reference video signature has a frequency of occurrence above a threshold (e.g., above a threshold number of content items), the reference video signature may be considered a frequent video signature, and thus, excluded, or removed, from the reference video signatures received from the video signature generator 402. For example, if a reference video signature has a frequency of occurrence below a threshold (e.g., below a threshold number of content items), the reference video signature may be considered a unique video signature, and thus, kept in the reference video signatures received from the video signature generator 402, or sent by the signature filter 403 to be matched, at 404, against video signatures received from user devices. In an example, the frequency of occurrence may be indicative of a level of uniqueness associated with a video signature. For example, a low frequency of occurrence of a video signature may be indicative of a high level of uniqueness of the video signature. The signature filter 403 may send the filtered reference video signatures to be matched, at 404, against target video signatures received from one or more user devices.

As an example, the signature filter 403 may be configured to associate the reference video signatures with metadata based on the frequency of occurrence of the reference video signatures. For example, a reference video signature may be determined to be a frequent video signature based on a determination that the frequency of occurrence of the reference video signature is above the threshold (e.g., above a threshold number of content items), and thus, metadata may be associated with the frequent reference video signature. For example, the metadata may comprise information indicative of one or more of a content identifier, a content type, or a content category. In addition, a target video signature associated with a content item may be received by the computing device, wherein the computing device may be configured to associate metadata with the target video signature based on a determination that a frequency of occurrence associated with the target video signature is above the threshold. The metadata associated with the target video signature may be matched with the metadata associated with the reference video signature to determine the content item associated with the target video signature.

As an example, the signature filter 403 may be configured to associate one or more shot signatures of a video signature with metadata. For example, a frequency of occurrence, or a level of frequency, may be determined for the one or more shot signatures. The frequency of occurrence, or the level of frequency, may comprise data indicative of a quantity of times the at least one shot signature appears in the video signature. At least one shot signature of the one or more shot signatures may be determined as a frequent shot signature based on a frequency of occurrence of the at least one shot signature satisfying the threshold. For example, the at least one shot signature of the one or more shot signatures may be determined as a frequent shot signature based on a determination that the frequency of occurrence of the at least one shot signature is above a threshold (e.g., above a threshold number of times in the video signature). In an example, the at least one shot signature may be determined as a frequent shot signature based on a determination that the level of frequency of the at least one shot signature is above the threshold. The at least one shot signature may be associated with metadata based on determining that the at least one shot signature is a frequent shot signature.

As an example, the signature filter 403 may be configured to filter the reference video signatures from the video signature generator 402 based on a machine learning algorithm. For example, a plurality of video signatures associated with a plurality of content items may be determined, wherein each video signature of the plurality of video signatures may be labeled according to a video signature frequency of occurrence. A plurality of features for a predictive model (e.g., machine learning model/algorithm) may be determined based on the plurality of video signatures. The plurality of features may comprise a plurality of frequencies of occurrence associated with the plurality of video signatures. The predictive model may be trained according to the plurality of features based on a first portion of the plurality of video signatures. As an example, training the predictive model based on the first portion of the plurality of the plurality of video signatures may result in determining a feature signature indicative of at least one video signature frequency of occurrence of a plurality of video signature frequencies of occurrence. The predictive model may be tested based on a second portion of the plurality of video signatures. The predictive model may be output based on the testing. The predictive model may be configured to output a prediction indicative of a frequency of occurrence associated with a video signature. The signature filter 403 may be configured to determine a frequency of occurrence associated with the reference video signatures received form the video signature generator 402 based on the trained predictive model (e.g., machine learning model/algorithm).

As an example, target video signatures received from the one or more user devices may be compared, at 404, with the reference video signatures from the signature filter 403. In an example, the target video signatures may be matched with the reference video signatures that have not been excluded, or removed, via the signature filter 403. In an example, one or more of the target signatures may be determined to be frequent video signatures and one or more of the target video signatures may be determined to be unique video signatures. The frequent target video signatures may be compared with the frequent reference video signatures and the unique target video signatures may be compared with the unique reference video signatures. In an example, metadata associated with frequent reference video signatures may be used to determine one or more content items associated with the frequent target video signatures that are matched with one or more of the frequent reference video signatures.

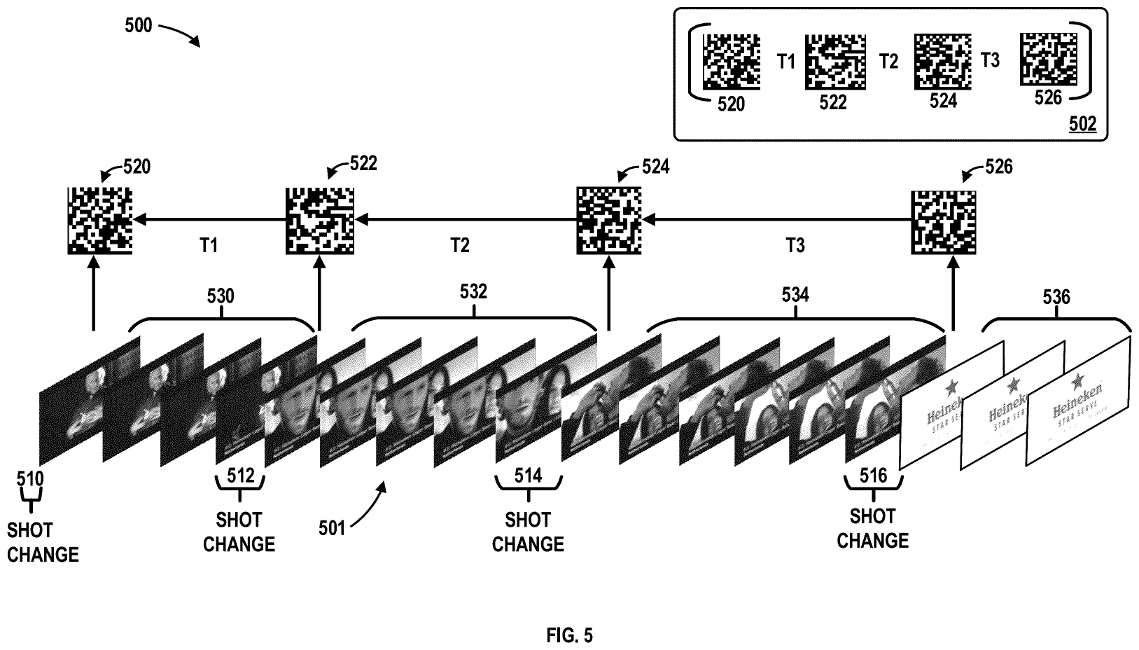

FIG. 5 shows an example video signature generation process 500. The video signature generation process 500 may be implemented by a device (e.g., devices 102, network devices 116, computing devices 104, etc.). The device may determine/receive a content item comprising one or more frames 501. One or more frame representations may be generated from the one or more frames 501 of the content item. For example, each frame representation may be generated based on a pixel average associated with each area of a plurality of areas of each frame of the content item. One or more shot changes 510, 512, 514, 516 may be determined based on the one or more frame representations. For example, each shot change 510, 512, 514, 516 may be determined based on a content transition of the content item from a first camera perspective in a frame of the content item to a second camera perspective in a frame of the content item. Timing information T1, T2, T3 may be determined based on each shot change 510, 512, 514, 516. For example, the timing information T1, T2, T3 may comprise information indicative of one or more of a time duration between a first shot change and a second shot change or a number of frames between a first shot change and a second shot change. For example, timing information T1 may be associated with the interval between shot changes 510 and 512, timing information T2 may be associated with the interval between shot changes 512 and 514, and timing information T3 may be associated with the interval between shot changes 514 and 516. A shot signature 520, 522, 524, 526 may be generated for each shot change 510, 512, 514, 516 of the content item. For example, shot signature 520 may correspond to shot change 510, shot signature 522 may correspond to shot change 512, shot signature 524 may correspond to shot change 514, and shot signature 526 may correspond to shot change 516. For example, one or more groups of frame representations 530, 532, 534, 536 may be determined for each shot change 510, 512, 514, 516. For example, a first group of frame representations 530 may be determined based on shot change 510, a second group of frame representations 532 may be determined based on shot change 512, a third group of frame representations 533 may be determined based on shot change 513, and a fourth group of frame representations 534 may be determined based on shot change 514. A shot signature 520, 522, 524, 526 may be generated from each first frame representation of the one or more groups of frame representations 530, 532, 534, 536. For example, each shot signature 520, 522, 524, 526 may comprise a color layout descriptor (CLD) 520, 522, 524, 526, wherein the CLD 520, 522, 524, 526 may comprise data indicative of a spatial layout of the dominant colors on a grid superimposed on a frame of the content item. For example, each shot signature 520, 522, 524, 526 may be generated based on applying a cosine transformation to each first frame representation. A video signature 502 of the content item may be generated based on the one or more shot signatures 520, 522, 524, 526 of the content item and the timing information T1, T2, T3 of the content item. For example, the video signature 502 may comprise the one or more shot signatures 520, 522, 524, 526 of the content item and the timing information T1, T2, T3 between each shot signature, as shown in FIG. 5.

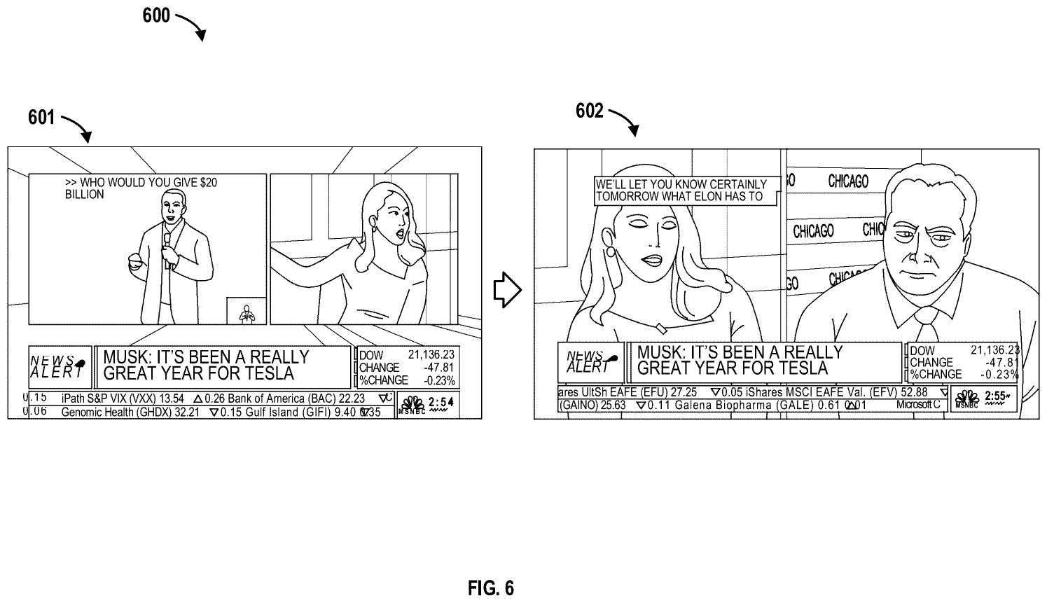

FIG. 6 shows an example shot change 600. For example, a content item may comprise several scenes of content, such as scenes 601 and 602. A first scene may be a conversation between two characters of the TV show discussing the characters' plans for a road trip for the upcoming weekend. The next scene may be the two characters in a car driving on the road trip the characters discussed. Thus, the scene change acts as a cue to the viewer that a transition has occurred between discussing the characters plans for the road trip, and when the characters are on the road trip, without needing additional explanation as to what occurred between the discussion and the start of the road trip. For example, a shot change 600 may comprise a content transition of a content item between different camera perspectives from a first frame of the content item to a second frame of the content item. For example, the content transition may change from a first camera perspective in frame 601 to a second camera perspective in frame 602. Frame 601 may be a view of a scene of a TV show including a woman host and a video of an individual. The camera perspective may then transition to frame 602, which may include a view of the same scene, but instead of the video of the individual, the woman host may be discussing the subject matter of the video with another individual. The transition from frame 601 to frame 602 may be a shot change because of the change in camera perspective from frame 601 to frame 602. In an example, the shot change 600, or content transition, may be determined based on measuring a difference between two adjacent scenes 601 and 602. For example, a large difference between two adjacent scenes 601 and 602 may be associated with a content transition between the first camera perspective in frame 601 to the second camera perspective in frame 602. Thus, the shot change 600, or shot transition, may be determined based on the difference between two adjacent scenes satisfying a difference threshold.

In an example, metadata associated with the content item may be determined along with the content item. The shot change may be detected based on SCTE-35 signaling in the metadata to determine one or more segment breaks in the content item, and thus, identifying the shot change. For example, the shot change may comprise a start or end of a commercial or a start or end of a scene. In an example, the shot change may be determined based on one or more shot change algorithms. For example, image packets for color and edge information may be decoded from the content item. Movement(s) may be detected from a first frame to a second frame based on the color and edge information. For example, the shot changes may be determined by comparing color histograms of adjacent video frames and applying a threshold to the difference of the color histograms between the adjacent video frames. For example, the shot change may be determined based on the difference in the color histograms between the adjacent frames exceeding the threshold.

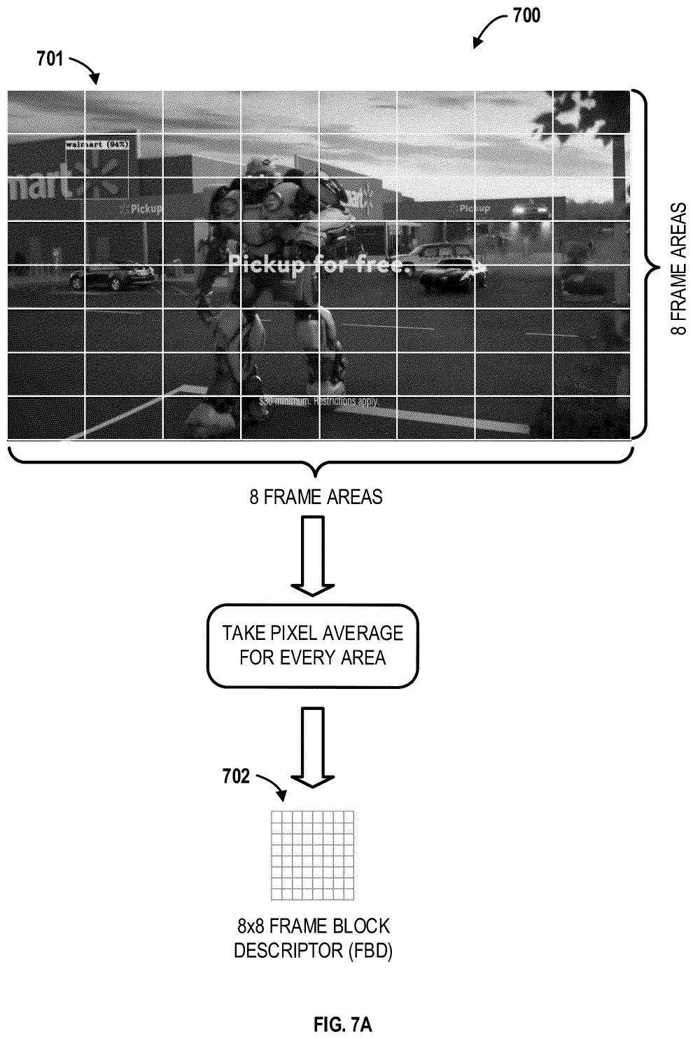

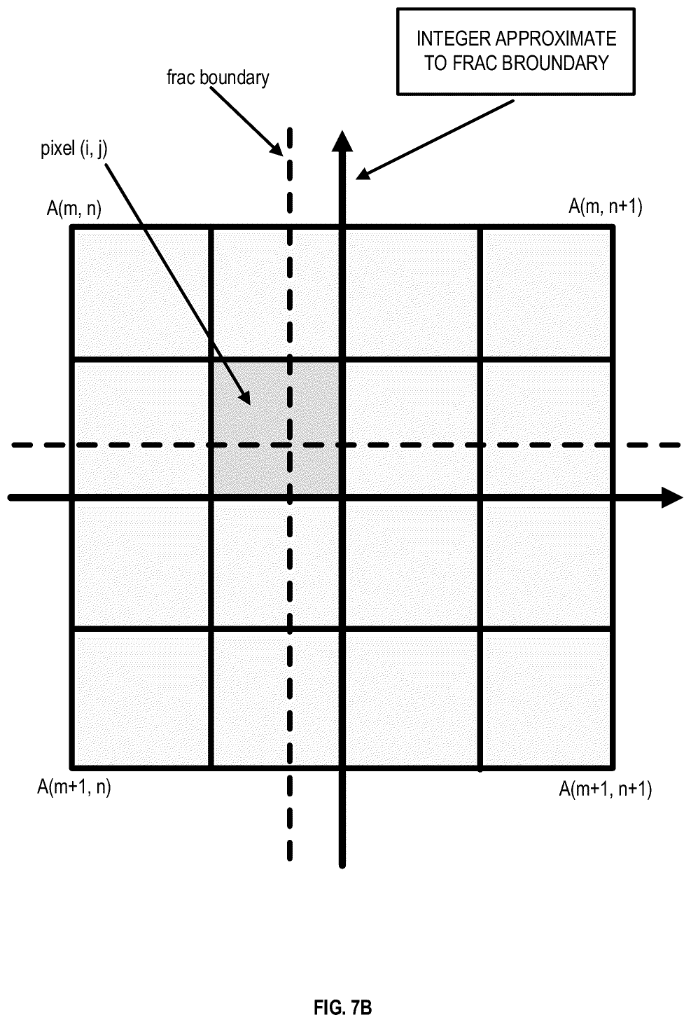

FIGS. 7A-7B show an example frame block descriptor (FBD) generation process 700. For example, a frame 701 of a content item may be partitioned into 64 areas (e.g., 8×8 areas). A pixel average may be determined for each area of the 64 areas of the frame partition. For example, the frame 701 of the content item may be resized by downsizing the original frame 701 (e.g., 1920×1080 pixels) to the FBD 702 (e.g., 8×8 pixels). The downsizing of the original frame 701 to the FBD 702 may avoid fractional pixel accumulation by allowing a variable size area partition. This may allow all pixels to be loaded and used once, and thus, pixel buffers would not be needed. FIG. 7B shows an example algorithm that avoids fractional pixel accumulation by varying the areas of the frame used for accumulation. As shown in FIG. 7B, A(m,n) refers to each of the areas (e.g., 64 or 8×8 areas) of a frame of a content item, wherein each area may be determined based on a pixel average of the frame. The fractional boundary of the pixel areas may be determined by dividing the total number of pixels in one dimension of the frame (e.g, 540 pixels) by the number of areas in the same dimension of the frame (e.g. 8 areas). For example, if the frame is 540 pixels in height, and the frame is to be partitioned into 8 pixel areas in the height dimension, each area may encompass 540/8=67.5 pixels in its accumulation. Because the number of pixels in each area is fractional (not a whole number), the averaging process may involve more mathematical operations than if the area boundaries aligned to the pixel boundaries. This is because when there is a fractional boundary, a single pixel value may contribute to four different area accumulations, as shown in FIG. 7B, for pixel(i,j). As shown in FIG. 7B, the downsizing may avoid fractional pixel accumulation by approximating the area boundaries to the nearest whole number. For example, if a frame height of 540 pixels is partitioned into 8 pixel areas, some areas may comprise a height of 67 pixels in the area accumulation, while other areas may comprise a height of 68 pixels.

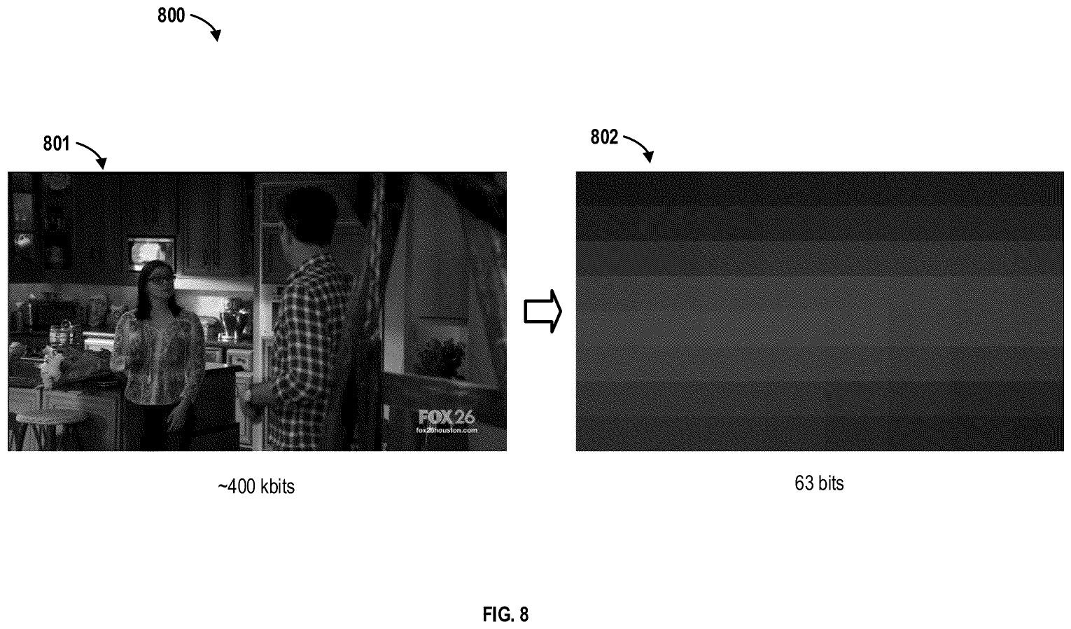

FIG. 8 shows an example color layout descriptor (CLD) process 800. For example, a shot signature 802 may be generated based on a frame representation (e.g., FBD) of a frame 801 of a content item. The shot signature 802 may comprise a CLD 802. The CLD 802 may be generated based on applying a cosine transformation to the frame representation. For example, the CLD 802 may comprise a spatial layout of the dominant colors on a grid superimposed on a frame of the content item. The CLD 802 is independent of image size and is a compact descriptor that allows for efficient/fast browsing and searching. As an example, the original frame 801 of the content item may comprise approximately 400,000 bits while the CLD 802 may comprise approximately 63 bits.

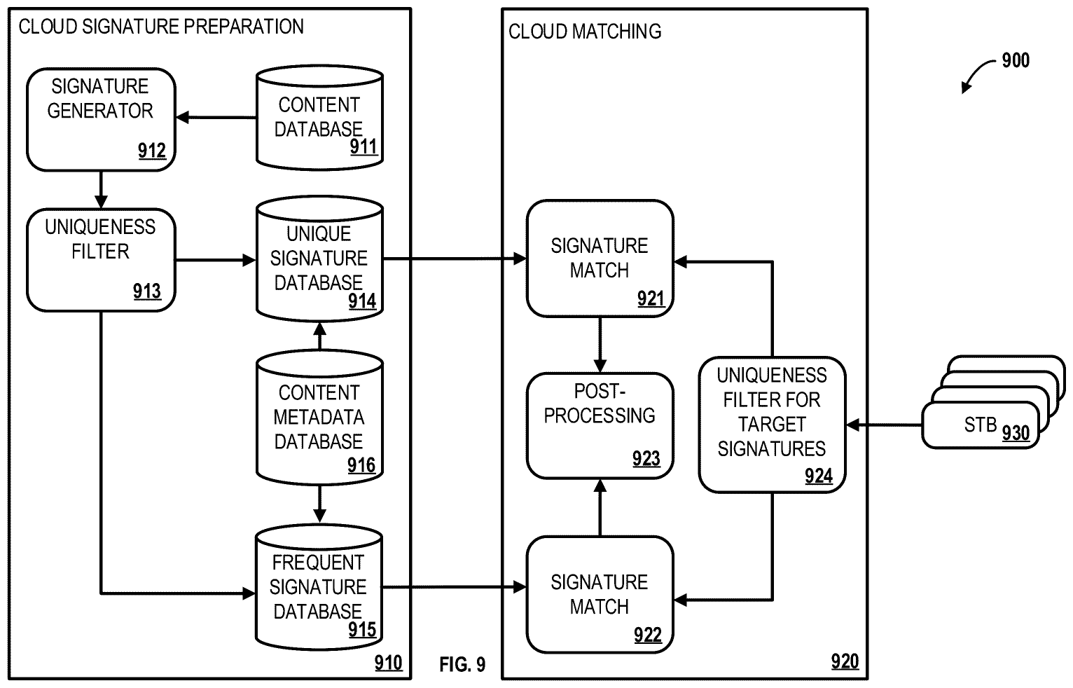

FIG. 9 shows an example system 900 for processing target video signatures, received from one or more user devices 930 (e.g., smart television, smartphone, laptop, set top box, tablet, etc.), and reference video signatures, stored at a database of a computing device (e.g., server, headend, cloud computing device, etc.). For example, cloud signature preparation 910 may be performed on one or more content items stored at the content database 911 of the computing device. The one or more content items may be determined/received from a content database 911. The content database 911 may send the one or more content items to a signature generator 912, wherein the signature generator 912 may generate a reference video signature for each content item of the one or more content items. For example, the signature generator 912 may generate reference video signatures of the content items based on the one or more shot signatures of the content items and the timing information associated with the one or more shot signatures. In an example, the signature generator 912 may be configured to determine an optimum number of shot signatures to use for generating the video signatures. For example, single shot signature matching might not work if there are many different programs sharing the same shot signatures or different shot signatures with the same video signature. For example, movies produced by the same company may start with the same component intro. Thus, increasing the number of shot signatures used to generate a video signature may increase the uniqueness of the video signature. However, using too many shot signatures to generate the video signature may increase the latency, or time it takes, to generate the video signature. As an example, an optimum number of shot signatures used to generate a video signature may be determined based on content type of a content item used to generate the video signature, a uniqueness of the shot signatures that may be used to generate the video signature, a determination that a length of time associated with a shot signature is greater than a threshold (e.g., threshold time duration/length), or a time duration/length of the content item. The signature generator 912 may send the one or more reference video signatures to the uniqueness filter 913.

The uniqueness filter 913 may process the one or more reference video signatures to determine one or more unique reference video signatures and one or more frequent reference video signatures. For example, the uniqueness filter 913 may filter the reference video signatures received from the signature generator 912 based on one or more filtering processes. For example, the uniqueness filter 913 may be configured to determine a frequency of occurrence for each reference video signature received from the signature generator 912. The frequency of occurrence may comprise data indicative of a quantity of times a reference video signature is associated with one or more content items. Reference video signatures with a high frequency of occurrence may be sent to a frequent signature database 915. Reference video signatures with a low frequency of occurrence may be sent to a unique signature database 914. For example, if a reference video signature has a frequency of occurrence above a threshold (e.g., above a threshold number of content items), the reference video signature may be considered a frequent video signature, and thus, sent to the frequent signature database 915. For example, if a reference video signature has a frequency of occurrence below a threshold (e.g., below a threshold number of content items), the reference video signature may be considered a unique video signature, and thus, sent to the unique signature database 914.

A content metadata database 916 may send content metadata to the unique signature database 914 and the frequent signature database 915. The content metadata may comprise information indicative of one or more of a content identifier, a content type, or a content category. In an example, the unique signature database 914 may add content metadata to each unique reference video signature and the frequent signature database 915 may add content metadata to each frequent reference video signature. The unique reference video signatures may be used to improve a matching accuracy against target video signatures received from the user devices. The frequent reference video signatures may be used, together with the content metadata to narrow the search scope. For example, if content metadata indicating a content source of the associated reference video signature is matched against a target video signature, the target video signature may not need to be matched against other content metadata indicating other content sources. The unique signature database 914 may send the unique reference video signatures to a signature matching component 921 of a cloud matching device 920 and the frequent signature database 915 may send the frequent reference video signatures to a signature matching component 922 of the cloud matching device 920.

The cloud matching device 920 may receive one or more target video signatures from one or more user devices 930 (e.g., set top boxes (STBs), display devices, laptops, smartphones, etc.). For example, the cloud matching device 920 may receive the one or more target video signatures at a uniqueness filter 924. Similar to the uniqueness filter 913, the uniqueness filter 924 may process the one or more target video signatures to determine one or more unique target video signatures and one or more frequent target video signatures. For example, the uniqueness filter 924 may filter the target video signatures received from the one or more user devices 930 based on one or more filtering processes. For example, the uniqueness filter 924 may be configured to determine a frequency of occurrence for each target video signature received from the one or more user devices 930. The frequency of occurrence may comprise data indicative of a quantity of times a target video signature is associated with one or more content items. Target video signatures with a high frequency of occurrence may sent to signature matching component 922. Target video signatures with a low frequency of occurrence may sent to signature matching component 921. For example, if a target video signature has a frequency of occurrence above a threshold (e.g., above a threshold number of content items), the target video signature may be considered a frequent video signature, and thus, sent to the signature matching component 922. For example, if a target video signature has a frequency of occurrence below a threshold (e.g., below a threshold number of content items), the target video signature may be considered a unique video signature, and thus, sent to the signature matching component 921.

The cloud matching device 920 may compare the unique reference video signatures with the unique target video signatures, via signature matching component 921, to determine whether one or more unique reference video signatures match one or more unique target video signatures. In addition, the cloud matching device 920 may compare the frequent reference video signatures with the frequent target video signatures, via signature matching component 922, to determine whether one or more frequent reference video signatures match one or more frequent target video signatures. In an example, the frequent target video signatures may be matched with the frequent reference video signatures. The content metadata associated with the frequent reference video signatures may be used to determine the content items associated with the matched frequent target video signatures. For example, the content metadata of the frequent reference video signatures may be compared with the content metadata of the frequent target video signatures to determine whether one or more frequent reference video signatures associated with the content metadata match one or more frequent target video signatures associated with the content metadata.

In an example, the signature matching components 921/922 may be configured to adjust a match threshold used for comparing the target video signatures (e.g., unique target video signatures and frequent target video signatures) to the reference video signatures (e.g., unique reference video signatures and frequent reference video signatures) in order to determine the content items associated with the target video signatures. For example, the signature matching components 921/922 may be configured to determine an indication of a quality metric associated with a target video signature. In an example, the reference video signatures may be associated with indications of quality metrics associated with the reference video signatures. The quality metrics may comprise one or more of an aspect ratio, a resolution, or a frame rate. A quality metric associated with a target video signature may be determined to be different than a quality metric associated with the reference video signature. Based on the difference, the match threshold may be adjusted. For example, content items output by the user devices 930 may be associated with a different content quality (e.g., aspect ratio, resolution, frame rate, etc.) than the content items stored at the content database 910. For example, standard definition content may have been used to generate the target video signatures while high definition content may have been used to generate the reference video signatures. Thus, there may be slight differences between the target video signatures from the user devices 930 and the reference video signatures stored in the content database 910. A match threshold (e.g., an adjustable tolerance) may be used to determine how closely a target video signature needs to match a reference video signature in order to determine the content item associated with the target video signature. For example, if a difference between a target video signature and a reference video signature satisfies the match threshold, the signature matching components 921/922 may determine that the target video signature matches the reference video signature. Thus, the content item associated with the reference video signature may be used to determine that the target video signature is associated with the content item.

In an example, the signature matching components 921/922 may be configured to adjust the match threshold based on one or more device parameters associated with a user device 930. The one or more device parameters may comprise one or more of network conditions or device capabilities. For example, network bandwidth conditions or device capabilities may affect the quality of the content item output by the user device 930. In an example, as a result of low network bandwidth conditions, a standard definition version of the content item may be processed in order to generate the target video signature. In an example, the user device may only be capable of processing a low resolution, or a low frame rate, version of the content resulting in the target video signature being generated from a low quality version of a content item. Thus, the match threshold may be adjusted based on the one or more device parameters in order to determine how closely a target video signature needs to match a reference video signature to determine the content item associated with the target video signature.

As an example, the cloud matching device 920 may be configured to further process the unique video signature matches and the frequent video signature matches via a post-processing component 923. As an example, if content metadata indicating a content source of the associated reference video signature is matched against a target video signature, the target video signature may not need to be matched against other content metadata indicating other content sources. As an example, content metadata that may be indicative of a multi-episode program may be associated with one or more reference video signatures. A target video signature may be associated with similar content metadata, wherein the target video signature's content metadata may be matched with the content metadata associated with the one or more reference video signatures. The target video signature may be determined to be associated with a content item associated with an episode of the multi-episode program based on the matching of the content metadata.

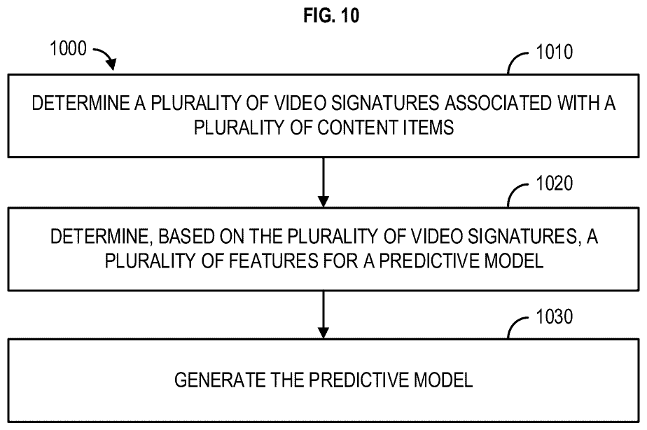

FIG. 10 shows a flowchart of an example method 1000 for generating a predictive model comprising receiving a plurality of video signatures associated with a plurality of content items at 1010, determining, based on the plurality of video signatures, a plurality of features for a predictive model at 1020, and generating, based on the plurality of features, a predictive model at 1030.

Determining the plurality of video signatures associated with the one or more content items at 1010 may comprise downloading/obtaining/receiving video signature data sets, obtained from various sources, including recent publications and/or publically available databases. Each video signature of the plurality of video signatures may be labeled according to a video signature frequency of occurrence. The video signature frequency of occurrence may comprise a quantity of times the video signature is associated with the plurality of content items.

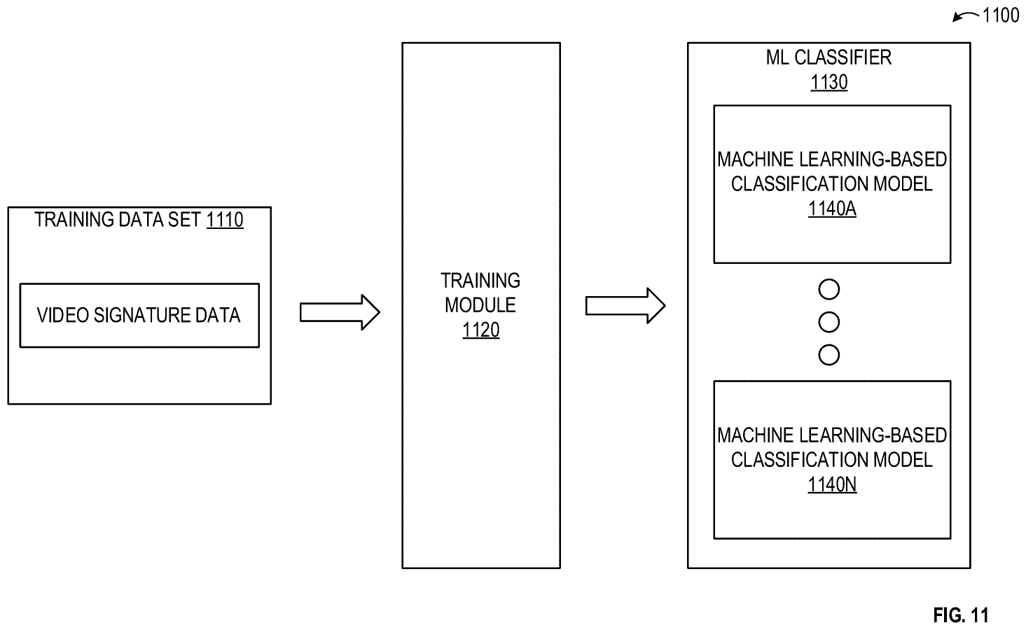

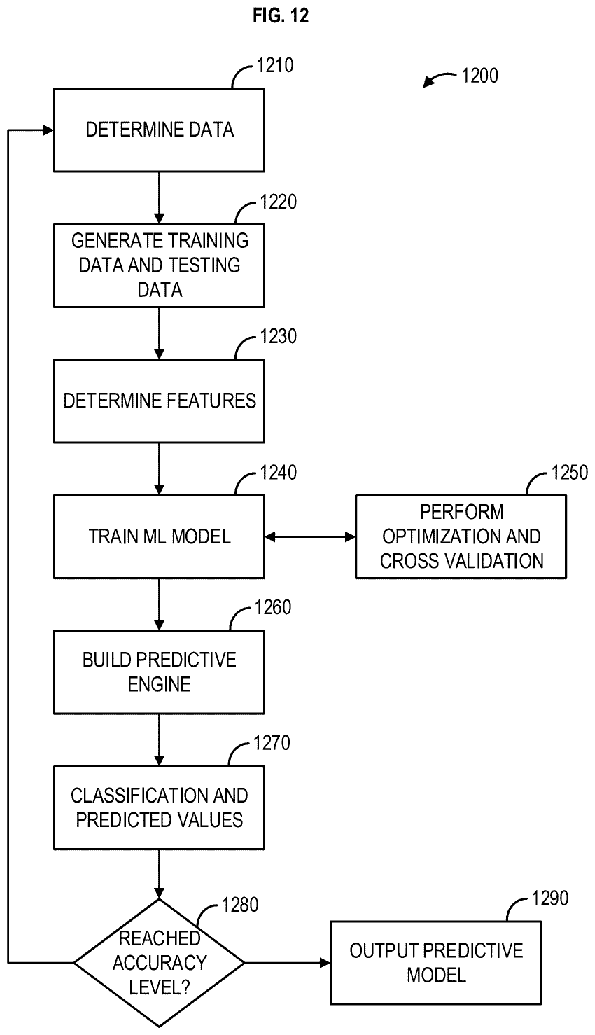

Determining, based on the plurality of video signatures, a plurality of features for a predictive model at 1020 and generating, based on the plurality of features, a predictive model at 1030 are described with respect to FIG. 11 and FIG. 12.

A predictive model (e.g., a machine learning classifier) may be generated to provide a prediction indicative of a frequency of occurrence of a video signature associated with a content item. The frequency of occurrence may comprise a quantity of times the video signature is associated with the plurality of content items. The predictive model may be trained according to the plurality of video signatures (e.g. one or more video signature data sets and/or baseline feature levels). The baseline feature levels may relate to one or more groups of video signatures. In an example, one or more features of the predictive model may be extracted from one or more of the video signature data sets and/or the baseline feature levels.

FIG. 11 shows a system 1100 that is configured to use machine learning techniques to train, based on an analysis of one or more training data sets 1110 by a training module 1120, at least one machine learning-based classifier 1130 that is configured to classify expected consumer preference results. As an example, the training data set 1110 (e.g., video signature data) may comprise the one or more video signature data sets and/or baseline feature levels. As an example, the one or more video signature data sets 1110 may comprise one or more groups of video signatures. Each group of video signatures of the one or more groups of video signatures may be associated with a baseline feature level such as a frequency of occurrence, a range of frequencies of occurrence, or a group of frequencies of occurrence. As an example, the training data set 1110 may comprise labeled baseline feature levels (e.g., baseline frequencies of occurrence). The labels may comprise a plurality of predefined features associated with one or more frequencies of occurrence. In an example, the plurality of predefined features may be associated with the one or more frequencies of occurrence.

The training module 1120 may train the machine learning-based classifier 1130 by extracting a feature set from the plurality of video signatures (e.g., one or more video signature data sets and/or baseline feature levels) in the training data set 1110 according to one or more feature selection techniques.

In an example, the training module 1120 may extract a feature set from the training data set 1110 in a variety of ways. The training module 1120 may perform feature extraction multiple times, each time using a different feature-extraction technique. The feature sets generated using the different techniques may each be used to generate different machine learning-based classification models 1140. As an example, the feature set with the highest quality metrics may be selected for use in training. The training module 1120 may use the feature set(s) to build one or more machine learning-based classification models 1140A-1140N that are configured to indicate whether or not new data is associated with one or more frequencies of occurrence. The one or more frequencies of occurrence may comprise information indicative of a quantity of times the video signature is associated with the plurality of content items.

In an example, the training data set 1110 may be analyzed to determine one or more groups of video signatures that have at least one feature that may be used to predict the one or more frequencies of occurrence. For example, each video signature may comprise one or more shot signatures and timing information associated with the one or more shot signatures. Each shot signature may comprise a color layout descriptor (CLD) generated from a frame of a content item. The CLD may comprise data indicative of a spatial layout of the dominant colors on a grid superimposed on a frame of the content item. The timing information may comprise information indicative of one or more of a time duration between a first shot change and a second shot change or a number of frames between a first shot change and a second shot change. As an example, the at least one feature may comprise at least one grouping of one or more CLDs and timing information of one or more groupings of one or more CLDs and timing information. The one or more groups of video signatures data may be considered as features (or variables) in the machine learning context. The term “feature,” as used herein, may refer to any characteristic of a group, or a series, of video signatures that may be used to determine whether the group of video signatures fall within one or more specific categories.

In an example, a feature selection technique may comprise one or more feature selection rules. The one or more feature selection rules may comprise a frequency of occurrence “occurrence rule.” The frequency of occurrence “occurrence rule” may comprise determining which frequencies of occurrence, group of frequencies of occurrence, or range of frequencies of occurrence, in the training data set 1110 occur over a threshold number of times for one or more groups of video signatures and identifying those which frequencies of occurrence for each group of video signatures that satisfy the threshold as candidate features. For example, any frequency of occurrence, group of frequencies of occurrence, or range of frequencies of occurrence, that appear greater than or equal to 50 times in the training data set 1110 may be considered as candidate features. Any frequency of occurrence, group of frequencies of occurrence, or range of frequencies of occurrence, appearing less than 50 times may be excluded from consideration as a feature.

In an example, the one or more feature selection rules may comprise a significance rule. The significance rule may comprise determining, from the baseline feature level data in the training data set 1110, frequencies of occurrence data. The frequency of occurrence data may include data associated with one or more frequencies of occurrences associated one or more groups of video signatures. As the baseline feature level in the training data set 1110 are labeled according to one or more frequencies of occurrence, the labels may be used to determine a frequency of occurrence associated with a video signature.

In an example, a single feature selection rule may be applied to select features or multiple feature selection rules may be applied to select the features. For example, the feature selection rules may be applied in a cascading fashion, with the feature selection rules being applied in a specific order and applied to the results of the previous rule. For example, the frequency of occurrence “occurrence rule” may be applied to the training data set 1110 to generate a first list of features. The significance rule may be applied to features in the first list of features to determine which features of the first list satisfy the significance rule in the training data set 1110 and to generate a final list of candidate features.

The final list of candidate features may be analyzed according to additional feature selection techniques to determine one or more candidate feature signatures (e.g., groups, or series, of video signatures that may be used to predict one or more frequencies of occurrence). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., an expected frequency of occurrence result).

In an example, one or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature signatures. Backward elimination is an iterative method that begins with all features in the machine learning model. In each iteration, the least significant feature is removed until no improvement is observed on removal of features. As an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 1120 has generated a feature set(s), the training module 1120 may generate a machine learning-based classification model 1140 based on the feature set(s). The machine learning-based classification model 1140, may refer to a complex mathematical model for data classification that is generated using machine-learning techniques. In an example, this machine learning-based classifier may include a map of support vectors that represent boundary features. For example, boundary features may be selected from, and/or represent the highest-ranked features in, a feature set.

In an example, the training module 1120 may use the feature sets extracted from the training data set 1110 to build a machine learning-based classification model 1140A-1140N for each classification category (e.g., frequency of occurrence prediction). In an example, the machine learning-based classification models 1140A-1140N may be combined into a single machine learning-based classification model 1140. Similarly, the machine learning-based classifier 1130 may represent a single classifier containing a single or a plurality of machine learning-based classification models 1140 and/or multiple classifiers containing a single or a plurality of machine learning-based classification models 1140.

The extracted features (e.g., one or more candidate features and/or candidate feature signatures derived from the final list of candidate features) may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 1130 may comprise a decision rule or a mapping that uses the expression levels of the features in the candidate feature signature to predict a frequency of occurrence.

The candidate feature signature and the machine learning-based classifier 1130 may be used to provide a prediction indicative of one or more frequencies of occurrence in the testing data set. In an example, the result for each test includes a confidence level that corresponds to a likelihood or a probability that the corresponding test predicted a frequency of occurrence. The confidence level may be a value between zero and one that represents a likelihood that the corresponding test is associated with a frequency of occurrence. In one example, when there are two or more statuses (e.g., two or more expected frequencies of occurrence results), the confidence level may correspond to a value p, which refers to a likelihood that a particular test is associated with a first status. In this case, the value 1−p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known expected frequency of occurrence results for each test. In general, the top performing candidate feature signature will have results that closely match the known frequency of occurrence.

The top performing candidate feature signature may be used to predict the expected frequency of occurrence result. For example, a plurality of video signatures and/or baseline feature data may be determined/received. The plurality of video signatures and/or the baseline feature data may be provided to the machine learning-based classifier 1130 which may, based on the top performing candidate feature signature, predict/determine an expected frequency of occurrence result. The frequency of occurrence result may comprise an expected, or predicted, quantity of times a video signature is associated with a plurality of content items.

FIG. 12 shows a flowchart of an example training method 1200 for generating the machine learning-based classifier 1130 using the training module 1120. The training module 1120 may be implemented using supervised, unsupervised, and/or semi-supervised (e.g., reinforcement based) machine learning-based classification models 1140. The method 1200 illustrated in FIG. 12 is an example of a supervised learning method; variations of this example of training method are discussed below, however, other training methods may be analogously implemented to train unsupervised and/or semi-supervised machine learning models.

The training method 1200 may determine (e.g., access, receive, retrieve, etc.) video signature data comprising a plurality of video signatures at 1210. The video signature data may contain one or more datasets, wherein each dataset may be associated with a group of video signatures. As an example, each dataset may include a labeled list of predetermined features. For example, each dataset may comprise labeled feature data. Each video signature may comprise one or more shot signatures and timing information associated with the one or more shot signatures. Each shot signature may comprise a color layout descriptor (CLD) generated from a frame of a content item. The CLD may comprise data indicative of a spatial layout of the dominant colors on a grid superimposed on a frame of the content item. The timing information may comprise information indicative of one or more of a time duration between a first shot change and a second shot change or a number of frames between a first shot change and a second shot change. The labels may be associated with one or more frequencies of occurrence associated with at least one grouping of one or more CLDs and timing information of one or more groupings of one or more CLDs and timing information.

The training method 1200 may generate, at 1220, a training data set and a testing data set. The training data set and the testing data set may be generated by randomly assigning labeled feature data of individual features from the video signature data to either the training data set or the testing data set. In an example, the assignment of the labeled feature data of individual features may not be completely random. In an example, only the labeled feature data for a specific video signature data set may be used to generate the training data set and the testing data set. In an example, a majority of the labeled feature data for the specific video signature data set may be used to generate the training data set. For example, 75% of the labeled feature data for the specific video signature data set may be used to generate the training data set and 25% may be used to generate the testing data set. In an example, only the labeled feature data for the specific video signature data set may be used to generate the training data set and the testing data set.

The training method 1200 may determine (e.g., extract, select, etc.), at 1230, one or more features that can be used by, for example, a classifier to differentiate among different classifications (e.g., different expected frequency of occurrence results). The one or more features may comprise a group of video signature data sets. In an example, the training method 1200 may determine a set of features from the video signature data. In an example, a set of features may be determined from video signature data from a video signature data set different than the video signature data set associated with the labeled feature data of the training data set and the testing data set. In other words, the video signature data from the different video signature data set (e.g., curated video signature data sets) may be used for feature determination, rather than for training a machine learning model. In an example, the training data set may be used in conjunction with the video signature data from the different video signature data set to determine the one or more features. The video signature data from the different video signature data set may be used to determine an initial set of features, which may be further reduced using the training data set.

The training method 1200 may train one or more machine learning models using the one or more features at 1240. As an example, the machine learning models may be trained using supervised learning. As an example, other machine learning techniques may be employed, including unsupervised learning and semi-supervised. The machine learning models trained at 1240 may be selected based on different criteria depending on the problem to be solved and/or data available in the training data set. For example, machine learning classifiers can suffer from different degrees of bias. Accordingly, more than one machine learning model may be trained at 1240, optimized, improved, and cross-validated at 1250.

The training method 1200 may select one or more machine learning models to build a predictive model at 1260 (e.g., a machine learning classifier). The predictive model may be evaluated using the testing data set. The predictive model may analyze the testing data set and generate classification values and/or predicted values at 1270. Classification and/or prediction values may be evaluated at 1280 to determine whether such values have achieved a desired accuracy level. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly predicted a frequency of occurrence for a video signature or group of video signatures. For example, true negatives and true positives may refer to a number of times the predictive model correctly predicted a frequency of occurrence for a video signature or group of video signatures. Related to these measurements are the concepts of recall and precision. Generally, recall refers to a ratio of true positives to a sum of true positives and false negatives, which quantifies a sensitivity of the predictive model. Similarly, precision refers to a ratio of true positives a sum of true and false positives.

When a desired accuracy level is reached, the training phase ends and the predictive model may be output at 1290; when the desired accuracy level is not reached, however, then a subsequent iteration of the training method 1200 may be performed starting at 1210 with variations such as, for example, considering a larger collection of patient data.

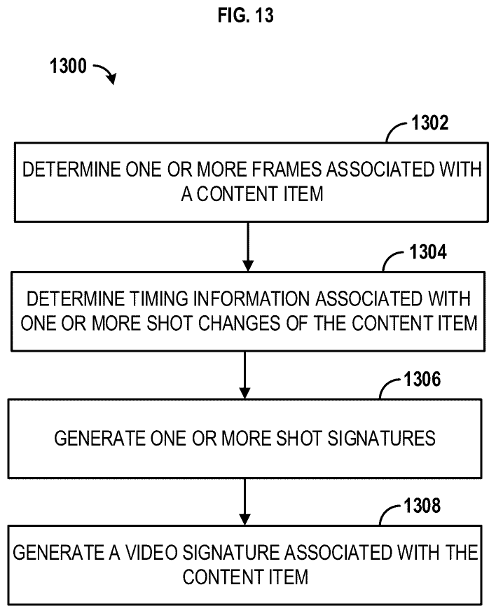

FIG. 13 shows an example method 1300 for generating a video signature of a content item. Method 1300 may be implemented by the devices 102, the computing device 104, or the network devices 116, or any combination thereof. For example, method 1300 may be implemented by a device comprising one or more of a smart television, a computer, a smartphone, a laptop, a tablet, a set top box, a server, headend, or a cloud computing device. At step 1302, one or more frames of a content item may be determined. As an example, the device (e.g., devices 102, the computing device 104, the network devices 116, etc.) may determine, or receive, the one or more frames of the content item. For example, a content item may comprise one or more frames of content. As an example, the device may output the one or more frames of the content item. As an example, the device may determine one or more frames of one or more content items stored in a database of the device.

At step 1304, timing information associated with one or more shot changes of the content item may be determined. For example, the timing information may be determined by the device (e.g., devices 102, the computing device 104, the network devices 116, etc.). In an example, timing information may be determined for each shot change. The timing information may comprise information indicative of one or more of a time duration between a first shot change and a second shot change or a number of frames between a first shot change and a second shot change. The one or more shot changes may be determined based on the one or more frames. For example, each shot change may be determined based on a content transition of the content item from a first camera perspective in a frame of the content item to a second camera perspective in a frame of the content item. In an example, the content transition may be determined based on measuring a difference (e.g., numeric difference) between two adjacent frames. For example, a large difference between the two adjacent frames may be associated with a content transition of the content item from a first camera perspective in a frame of the content item to a second camera perspective in a frame of the content item. Thus, the content transition may be determined based on the difference between one or more frames satisfying a difference threshold. For example, a numerical difference that is above the difference threshold may indicate that a content transition has occurred, while a numerical difference that is below the difference threshold may indicate that a content transition has not occurred.

In an example, the timing information may be determined based on one or more frame representations. A frame representation may be generated based on each frame of the content item. Each frame representation may comprise a frame block descriptor associated with a frame of the content item. The frame block descriptor is essentially a frame of the content item resized (e.g., downsized) from a first resolution to a second resolution. For example, a frame (e.g., 1920×1080 pixels) may be partitioned into 64 areas (8×8 pixel areas). A pixel average may be determined based on the pixels comprising each portioned area of the frame. This process may avoid fractional pixel accumulation by allowing variable size area partition. For example, all pixels may be loaded once and used once without the need for pixel buffers. The one or more shot changes may be determined based on measuring a difference (e.g., numeric difference) between two adjacent frames.

At step 1306, one or more shot signatures may be generated based on the one or more shot changes. For example, the one or more signatures may be generated by the device (e.g., devices 102, the computing device 104, the network devices 116, etc.) based on the one or more shot changes. As an example, a shot signature may be generated for each shot change of the content item. For example, one or more groups of frames may be determined for each shot change. A shot signature may be generated from each first frame of the one or more groups of frames. For example, each shot signature may comprise a color layout descriptor (CLD) of a frame of the content item. The CLD may comprise data indicative of a spatial layout of the dominant colors on a grid superimposed on a frame of the content item. For example, each CLD may be generated based on applying a cosine transformation to each first frame. The CLD is essentially a very compact descriptor associated with the frame and allows for improved efficiency when used by fast browsing and search applications, especially since the CLD is independent of the image size. For example, an original frame of the content item may comprise approximately 400,000 bits while the CLD may comprise approximately 63 bits. In an example, a time interval associated with a total length of time of the content item may be determined, wherein the one or more shot signatures may be generated based on the time interval.

At step 1308, a video signature of the content item may be generated based on the one or more shot signatures and the timing information. For example, the video signature may be generated by the device (e.g., devices 102, the computing device 104, the network devices 116, etc.) based on the one or more shot signatures and the timing information. As an example, the video signature may comprise the one or more shot signatures of the content item and the timing information between each shot signature of the one or more shot signatures. For example, the video signature may comprise each shot signature generated from the content item and timing data (e.g., the timing information) between each shot signature such as the video signature 502 shown in FIG. 5, for example.

In an example, the video signature may be sent. For example, a user device (e.g., devices 102, the network devices 116, etc.) may send the video signature to a computing device (e.g., server, headend, cloud computing device, computing device, 104, etc.). As an example, the computing device may compare the video signature received from the user device with one or more reference video signatures stored in a database of the computing device. For example, the computing device may implement method 1300 to generate one or more reference video signatures based on one or more content items stored in a database associated with the computing device while the user device may implement method 1300 to generate a video signature (e.g., target video signature) based on a content item output via the user device. The video signature received from the user device may be matched with a reference video signature to identify the content item associated with the video signature received from the user device.

In an example, the user device may receive viewing history information from the computing device. For example, the computing device may determine viewing history information associated with the identification of the content item, wherein the computing device may send the viewing history information to the user device. As an example, the user device may receive a content recommendation or receive an update of viewing history information considered by a content recommendation profile of the user device. For example, the computing device may determine a content recommendation based on the identification of the content item, wherein the computing device may send the content recommendation to the user device. For example, the computing device may determine an update to the viewing history information considered by the content recommendation profile, wherein the computing device may send the update to the viewing history information to the user device.

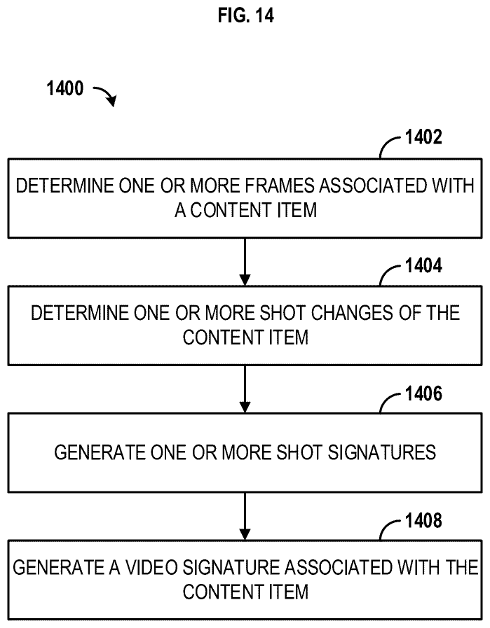

FIG. 14 shows an example method 1400 for generating a video signature of a content item. Method 1400 may be implemented by the devices 102, the computing device 104, or the network devices 116, or any combination thereof. For example, method 1400 may be implemented by a device comprising one or more of a smart television, a computer, a smartphone, a laptop, a tablet, a set top box, a server, headend, or a cloud computing device. At step 1402, one or more frames of a content item may be received. As an example, the device (e.g., devices 102, the computing device 104, the network devices 116, etc.) may determine, or receive, the one or more frames of the content item. For example, a content item may comprise one or more frames of content. As an example, the device may output the one or more frames of the content item. As an example, the device may determine one or more frames of one or more content items stored in a database of the device.

At step 1404, one or more shot changes of the content item may be determined based on the one or more frames. For example, the one or more shot changes may be determined by the device (e.g., devices 102, the computing device 104, the network devices 116, etc.) based on the one or more frames. For example, each shot change may be determined based on a content transition of the content item from a first camera perspective in a frame of the content item to a second camera perspective in a frame of the content item. In an example, the content transition may be determined based on measuring a difference (e.g., numeric difference) between two adjacent frames. For example, a large difference between the two adjacent frames may be associated with a content transition of the content item from a first camera perspective in a frame of the content item to a second camera perspective in a frame of the content item. Thus, the content transition may be determined based on the difference between one or more frames satisfying a difference threshold. For example, a numerical difference that is above the difference threshold may indicate that a content transition has occurred, while a numerical difference that is below the difference threshold may indicate that a content transition has not occurred.

In an example, the one or more shot changes may be determined based on one or more frame representations. A frame representation may be generated based on each frame of the content item. Each frame representation may comprise a frame block descriptor associated with a frame of the content item. The frame block descriptor is essentially a frame of the content item resized (e.g., downsized) from a first resolution to a second resolution. For example, a frame (e.g., 1920×1080 pixels) may be partitioned into 64 areas (8×8 pixel areas). A pixel average may be determined based on the pixels comprising each portioned area of the frame. This process may avoid fractional pixel accumulation by allowing variable size area partition. For example, all pixels may be loaded once and used once without the need for pixel buffers. The one or more shot changes may be determined based on measuring a difference (e.g., numeric difference) between two adjacent frames.

At step 1406, one or more shot signatures may be generated based on the one or more shot changes. For example, the one or more signatures may be generated by the device (e.g., devices 102, the computing device 104, the network devices 116, etc.) based on the one or more shot changes. As an example, a shot signature may be generated for each shot change of the content item. For example, one or more groups of frames may be determined for each shot change. A shot signature may be generated from each first frame of the one or more groups of frames. For example, each shot signature may comprise a color layout descriptor (CLD) of a frame of the content item. The CLD may comprise data indicative of a spatial layout of the dominant colors on a grid superimposed on a frame of the content item. For example, each CLD may be generated based on applying a cosine transformation to each first frame. The CLD is essentially a very compact descriptor associated with the frame and allows for improved efficiency when used by fast browsing and search applications, especially since the CLD is independent of the image size. For example, an original frame of the content item may comprise approximately 400,000 bits while the CLD may comprise approximately 63 bits. In an example, a time interval associated with a total length of time of the content item may be determined, wherein the one or more shot signatures may be generated based on the time interval.

At step 1408, a video signature of the content item may be generated based on the one or more shot signatures. For example, the video signature may be generated by the device (e.g., devices 102, the computing device 104, the network devices 116, etc.) based on the one or more shot signatures. For example, the video signature may comprise the one or more shot signatures generated based on the one or more shot changes. As an example, the video signature may comprise the video signature 502, as shown in FIG. 5 without the timing information, for example. In an example, the video signature may comprise the one or more shot signatures of the content item and timing information associated with the one or more shot changes. For example, timing information may be determined for each shot change. The timing information may comprise information indicative of one or more of a time duration between a first shot change and a second shot change or a number of frames between a first shot change and a second shot change.

In an example, the video signature may be sent. For example, a user device (e.g., devices 102, the network devices 116, etc.) may send the video signature to a computing device (e.g., server, headend, cloud computing device, computing device 104, etc.). As an example, the computing device may compare the video signature received from the user device with one or more reference video signatures stored in a database of the computing device. For example, the computing device may implement method 1400 to generate one or more reference video signatures based on one or more content items stored in a database associated with the computing device while the user device may implement method 1400 to generate a video signature (e.g., target video signature) based on a content item output via the user device. The video signature received from the user device may be matched with a reference video signature to identify the content item associated with the video signature received from the user device.

In an example, the user device may receive viewing history information from the computing device. For example, the computing device may determine viewing history information associated with the identification of the content item, wherein the computing device may send the viewing history information to the user device. As an example, the user device may receive a content recommendation or receive an update of viewing history information considered by a content recommendation profile of the user device. For example, the computing device may determine a content recommendation based on the identification of the content item, wherein the computing device may send the content recommendation to the user device. For example, the computing device may determine an update to the viewing history information considered by the content recommendation profile, wherein the computing device may send the update to the viewing history information to the user device.

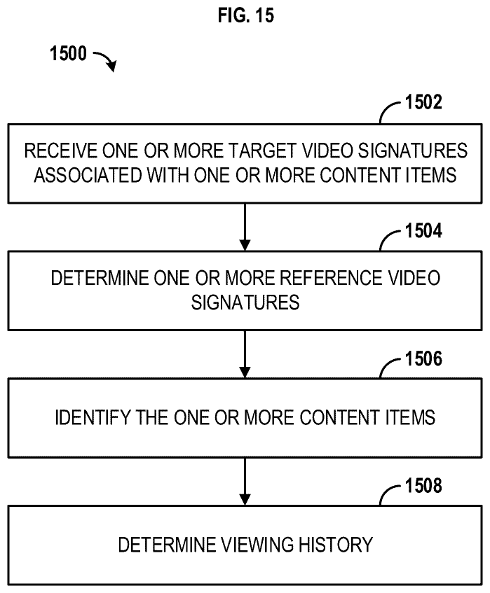

FIG. 15 shows an example method 1500 for generating a video signature of a content item. Method 1500 may be implemented by the computing device 104. For example, method 1500 may be implemented by a computing device comprising one or more of a server, headend, or a cloud computing device. At step 1502, one or more target video signatures associated with one or more content items may be received. For example, the computing device (e.g., computing device 104, etc.) may receive the one or more target video signatures from one or more user devices. For example, the one or more target video signatures may be sent by the one or more user device to the computing device as the one or more content items are being output by the one or more use devices. For example, the one or more target video signatures may be generated by the one or more user devices as the one or more content items are being output by the one or more user devices. Each target video signature may comprise one or more target shot signatures and timing information associated with the one or more target shot signatures.

At step 1504, one or more reference video signatures may be determined. For example, the one or more reference video signatures may be determined by the computing device (e.g., computing device 104, etc.). For example, the one or more reference video signatures may be generated based on one or more content items stored at a database of the computing device. In an example, the one or more reference video signatures may be stored at a video signature database of the computing device. Each reference video signature may comprise one or more reference shot signatures and timing information associated with the one or more reference shot signatures.

At step 1506, one or more content items may be identified based on the one or more target video signatures and the one or more reference video signatures. For example, the one or more content items may be identified by the computing device (e.g., computing device 104, etc.) based on the one or more target video signatures and the one or more reference video signatures. In an example, the one or more content items may be identified based on comparing the one or more target video signatures and the one or more reference video signatures. In an example, the one or more content items may be identified based on matching the one or more target video signatures with the one or more reference video signatures.

At step 1508, viewing history information may be determined. For example, the viewing history information may be determined by the computing device (e.g., computing device 104, etc.). For example, based on matching the one or more target video signatures with the one or more reference video signatures, the computing device may determine viewing history information associated with the one or more user devices. In an example, the computing device may update the viewing history information based on the identification of the at least one content item. In an example, the computing device may determine separate viewing history information for each user device of the one or more user devices. In an example, updating the viewing history information may comprise updating a viewing account associated with a user profile associated with a user device. For example, a count associated with the number of times a content item is output may be increased each time the content item is identified while it is output by the user device or each time a content item, whether a new content item or the same content item, is identified while it is output by the user device. In an example, viewing history information may be determined for one or more users associated with each user device.

As an example, a content recommendation may be sent based on the identification of the at least one content item. For example, the computing device may send one or more content recommendations to the one or more user devices based on the identification of the at least one content item. As an example, viewing history information considered by a content recommendation profile may be updated based on the identification of the at least one content item. For example, the computing device may update viewing history information considered by one or more content recommendation profiles based on the identification of the at least one content item.

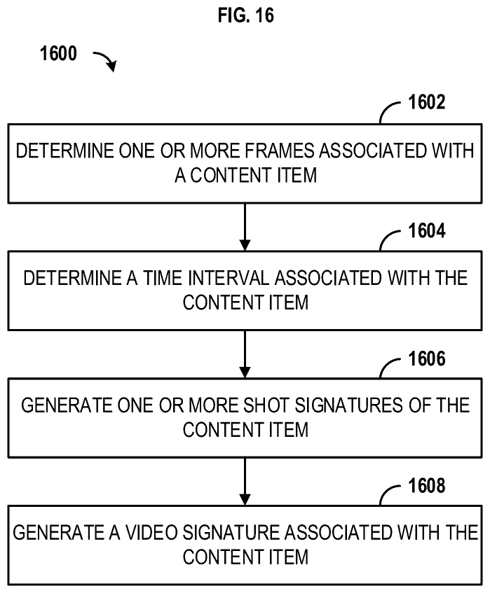

FIG. 16 shows an example method 1600 for generating a video signature of a content item. Method 1600 may be implemented by the devices 102, the network devices 116, or the computing device 104, or any combination thereof. For example, method 1600 may be implemented by a device comprising one or more of a smart television, a computer, a smartphone, a laptop, a tablet, a set top box, server, headend, or a cloud computing device. At step 1602, one or more frames of a content item may be determined. As an example, the device (e.g., devices 102, the network devices 116, the computing device 104, etc.) may determine, or receive, the one or more frames of the content item. For example, a content item may comprise one or more frames of content. As an example, the device may output the one or more frames of the content item. As an example, the content item may be stored in a database. The device may determine the one or more frames from the content item stored in the database.

At step 1604, a time interval associated with the content item may be determined based on the one or more frames of the content item. For example, the time interval associated with the content item may be determined by the device (e.g., devices 102, the network devices 116, the computing device 104, etc.) based on the one or more frames of the content item. For example, a total length of the content item may be determined. The time interval may be determined based on the total length of the content item. For example, the total length of the content item may be divided into a plurality of time intervals, wherein each time interval is equal to each other.

At step 1606, one or more shot signatures may be generated based on the time interval. For example, the one or more shot signatures may be generated by the device (e.g., devices 102, the network devices 116, the computing device 104, etc.) based on the time interval. As an example, one or more time periods may be determined based on the time interval. For example, a content may be divided into one or more equal periods (e.g., durations of time) based on the total length, or time interval, of the content item. The one or more shot signatures may be generated based on the frames of each time period. For example, one or more groups of frames may be determined for each time period. A shot signature may be generated from each first frame of the one or more groups of frames. Each shot signature may comprise a color layout descriptor (CLD). The CLD may comprise data indicative of a spatial layout of the dominant colors on a grid superimposed on a frame of a content item. For example, each shot signature may be generated based on applying a cosine transformation to each first frame. The CLD is essentially a very compact descriptor associated with the frame and allows for improved efficiency when used by fast browsing and search applications, especially since the CLD is independent of the image size. For example, an original frame of the content item may comprise approximately 400,000 bits while the CLD may comprise approximately 63 bits.

At step 1608, a video signature may be generated based on the one or more shot signatures. For example, the video signature may be generated by the device (e.g., devices 102, the network devices 116, the computing device 104, etc.) based on the one or more shot signatures. For example, the video signature may comprise the one or more shot signatures generated based on the one or more shot changes. As an example, the video signature may comprise the video signature 502, as shown in FIG. 5 without the timing information, for example. In an example, the video signature may further comprise timing information associated with the one or more shot changes. For example, timing information may be determined for each shot change. The video signature may comprise each shot signature generated from the content item and timing data (e.g., the timing information) between each shot signature such as the video signature 502 shown in FIG. 5, for example. The timing information may comprise information indicative of one or more of a time duration between a first shot change and a second shot change or a number of frames between a first shot change and a second shot change.

As an example, the video signature may be sent. For example, a user device (e.g., devices 102, the network devices 116, etc.) may send the video signature to a computing device (e.g., server, headend, cloud computing device, computing device 104, etc.). As an example, the computing device may compare the video signature received from the user device with one or more reference video signatures stored in a database of the computing device. For example, the computing device may implement method 1600 to generate one or more reference video signatures based on one or more content items stored in a database associated with the computing device while the user device may implement method 1600 to generate a video signature (e.g., target video signature) based on a content item output via the user device. The video signature received from the device may be matched with a reference video signature to identify the content item associated with the video signature received from the device.

As an example, the device may receive viewing history information from the computing device. For example, the computing device may determine viewing history information associated with the identification of the content item, wherein the computing device may send the viewing history information to the device. As an example, the device may receive a content recommendation or receive an update of viewing history information considered by a content recommendation profile of the device. For example, the computing device may determine a content recommendation based on the identification of the content item, wherein the computing device may send the content recommendation to the device. For example, the computing device may determine an update to viewing history information considered by the content recommendation profile, wherein the computing device may send the update to the viewing history information to the device.

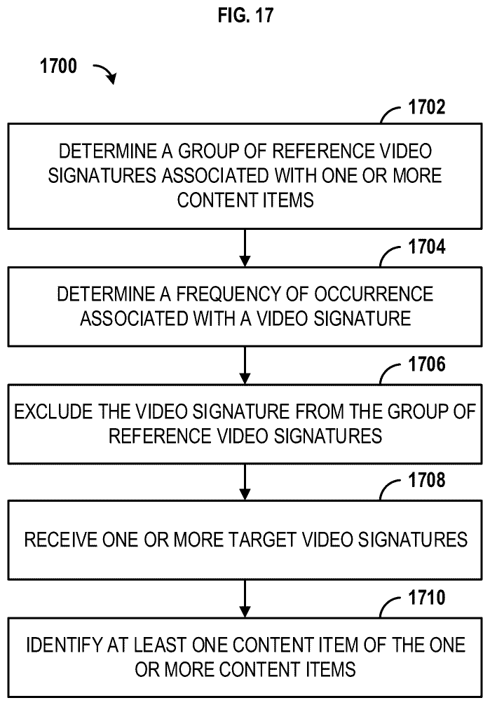

FIG. 17 shows an example method 1700 for filtering a database comprising one or more video signatures. Method 1700 may be implemented by the computing device 104. For example, method 1700 may be implemented by a computing device comprising one or more of a server, headend, or a cloud computing device. At step 1702, a group of reference video signatures associated with one or more content items may be determined. For example, the group of reference video signatures may be determined by the computing device (e.g., computing device 104, etc.). As an example, the group of reference video signatures may be stored in a reference database (e.g. reference database of reference video signatures used to identify content items). The reference database may be associated with the computing device.

At step 1704, a frequency of occurrence may be determined for a video signature. For example, the frequency of occurrence may be determined by the computing device (e.g., computing device 104, etc.) for the video signature. The video signature may be stored in a database of the computing device. The frequency of occurrence may comprise a quantity of times the video signature is associated with one or more content items. The video signature may comprise a plurality of shot signatures and timing information. Each shot signature may comprise a color layout descriptor (CLD) of a frame of a content item associated with the video signature. The CLD may comprise data indicative of a spatial layout of the dominant colors of a grid superimposed on a frame of the content item. Each shot signature may be generated based on a shot change of the content item. For example, the shot change may comprise a content transition of the content item from a first camera perspective in a frame of the content item to a second camera perspective in a frame of the content item. The timing information may comprise information indicative of one or more of a time duration between a first shot change and a second shot change or a number of frames between a first shot change and a second shot change.

At step 1706, the video signature may be excluded from the group of reference video signatures based on the frequency of occurrence satisfying a threshold. For example, the computing device (e.g., computing device 104, etc.) may exclude the video signature from the group of reference video signatures based on the frequency of occurrence satisfying the threshold. For example, the video signature may be determined as a frequent video signature based on a determination that the frequency of occurrence of the video signature is above the threshold (e.g., above a threshold number of content items), and thus, excluded, or removed, from the group of reference video signatures. For example, if the video signature is determined to be associated with 50 or more content items, the video signature may be determined as a frequent video signature and excluded from the group of reference video signatures. In an example, the video signature may be determined as a unique video signature based on a determination that the frequency of occurrence of the video signature is below the threshold (e.g., below a threshold number of content items), and thus, included in the group of reference video signatures. The reference database may comprise one or more reference video signatures associated with one or more content items (e.g., the group of reference video signatures).

At step 1708, one or more target video signatures associated with one or more content items may be received. For example, the one or more target video signatures may be received by the computing device (e.g., computing device 104, etc.) from one or more user devices. For example, the one or more target video signatures may be generated based on one or more content items output by the one or more user device. As an example, the one or more user devices may send the one or more target video signatures to the computing device to be identified based on the group of reference video signatures.

At step 1710, at least one content item may be identified based on the one or more target video signatures and the group of reference video signatures. For example, the at least one content item may be identified by the computing device (e.g., computing device 104, etc.) based on the one or more target video signatures and the group of reference video signatures. For example, the at least one content item may be determined based on matching a target video signature with at least one reference video signature of the group of reference video signatures. In an example, viewing history information may be determined. For example, the viewing history information may be determine for one or more user devices. The viewing history information may be updated based on the identification of the at least one content item. In an example, a content recommendation may be determined based on the identification of the at least one content item. For example, a content recommendation may be sent to, or caused at, one or more user devices based on the identification of the at least one content item. In an example, viewing history information considered by a content recommendation profile may be updated based on the identification of the at least one content item.

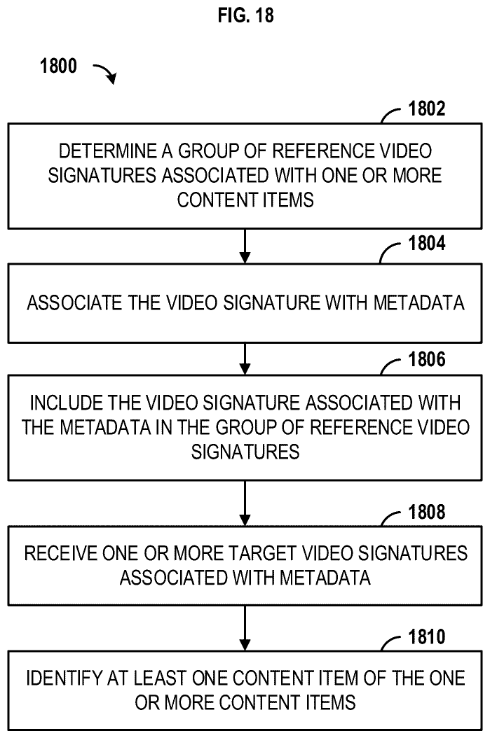

FIG. 18 shows an example method 1800 for filtering a database comprising one or more video signatures. Method 1800 may be implemented by the computing device 104. For example, method 1800 may be implemented by a computing device comprising one or more of a server, headend, or a cloud computing device. At step 1802, a group of reference video signatures associated with one or more content items may be determined. For example, the group of reference video signatures may be determined by the computing device (e.g., computing device 104, etc.). The group of reference video signatures may be associated with metadata. As an example, the group of reference video may be stored in a filter database (e.g., reference database of reference video signatures associated with metadata used to identify content items). The filter database may be associated with the computing device.

At step 1804, a video signature may be associated with metadata based on a frequency of occurrence associated with the video signature. For example, the video signature may be associated with the metadata by the computing device (e.g., computing device 104, etc.) based on the frequency of occurrence associated with the video signature. The frequency of occurrence may comprise a quantity of times the video signature is associated with one or more content items. The video signature may comprise a plurality of shot signatures and timing information. Each shot signature may comprise a color layout descriptor (CLD) of a frame of a content item associated with the video signature. The CLD may comprise data indicative of a spatial layout of the dominant colors on a grid superimposed on a frame of the content item. Each shot signature may be generated based on a shot change of the content item. For example, the shot change may comprise a content transition of the content item from a first camera perspective in a frame of the content item to a second camera perspective in a frame of the content item. The timing information may comprise information indicative of one or more of a time duration between a first shot change and a second shot change or a number of frames between a first shot change and a second shot change.

At step 1806, the video signature may be included in group of reference video signatures based on the frequency of occurrence satisfying a threshold. For example, the computing device (e.g., computing device 104, etc.) may include the video signature in the group of reference video signatures based on the frequency of occurrence satisfying the threshold. For example, the video signature may be determined as a frequent video signature based on a determination that the frequency of occurrence of the video signature is above the threshold (e.g., above a threshold number of content items), and thus, included in the group of reference video signatures. For example, if the video signature is determined to be associated with 50 or more content items, the video signature may be determined as a frequent video signature, and thus, included in the group of reference video signatures. In an example, the video signature may be determined as a unique video signature based on a determination that the frequency of occurrence of the video signature is below the threshold (e.g., below a threshold number of content items), and thus, excluded from the group of reference video signatures associated with the metadata.

In an example, the group of reference video signatures associated with the metadata may be stored in a filter database. The filter database may comprise one or more reference video signatures associated with metadata. For example, based on the determination that a frequency of occurrence of a video signature is above the threshold (e.g., associated above a threshold number of content items), metadata may be associated with the video signature. The video signature may be stored in the filter data associated with metadata. The metadata may comprise information indicative of one or more of a content identifier, a content type, or a content category.

At step 1808, one or more target video signatures associated with one or more content items may be received. For example, the one or more target video signatures may be received by the computing device (e.g., computing device 104, etc.) from one or more user devices. For example, the one or more target video signatures may be generated based on one or more content items output by the one or more user device. As an example, the one or more user devices may send the one or more target video signatures to the computing device to be identified based on the group of reference video signatures.

At step 1810, at least one content item may be identified based on the one or more target video signatures and the group of reference video signatures. For example, the at least one content item may be identified by the computing device (e.g., computing device 104, etc.) based on the one or more target video signatures and the group of reference video signatures. For example, the at least one content item may be determined based on matching a target video signature with at least one reference video signature of the group of reference video signatures. In an example, viewing history information may be determined. For example, the viewing history information may be determine for one or more user devices. The viewing history information may be updated based on the identification of the at least one content item. In an example, a content recommendation may be determined based on the identification of the at least one content item. For example, a content recommendation may be sent to, or caused at, one or more user devices based on the identification of the at least one content item. In an example, viewing history information considered by a content recommendation profile may be updated based on the identification of the at least one content item.

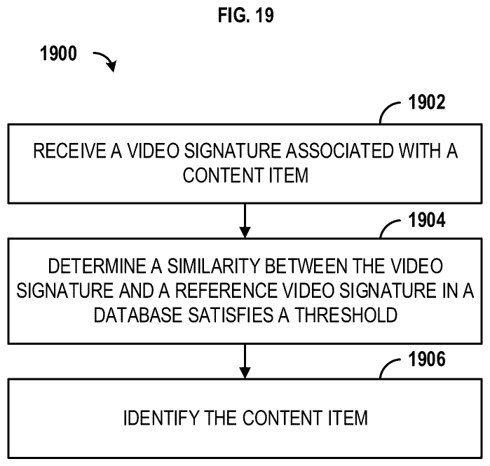

FIG. 19 shows an example method 1900 for filtering a database comprising one or more video signatures. Method 1900 may be implemented by the computing device 104. For example, method 1900 may be implemented by a computing device comprising one or more of a server, headend, or a cloud computing device. At step 1902, a video signature associated with a content item may be received. For example, the video signature may be received by the computing device (e.g., computing device 104, etc.) from a user device. The video signature may comprise a plurality of shot signatures and timing information. Each shot signature may comprise a color layout descriptor (CLD) of a frame of a content item associated with the video signature. The CLD may comprise data indicative of a spatial layout of the dominant colors on a grid superimposed on a frame of the content item. Each shot signature may be generated based on a shot change of the content item. For example, the shot change may comprise a content transition of the content item from a first camera perspective in a frame of the content item to a second camera perspective in a frame of the content item. The timing information may comprise information indicative of one or more of a time duration between a first shot change and a second shot change or a number of frames between a first shot change and a second shot change.

At step 1904, a similarity between the video signature and a reference video signature in a database satisfying a threshold may be determined. For example, the similarity between the video signature and the reference video signature in the database satisfying the threshold may be determined by the computing device (e.g., computing device 104, etc.). As an example, the video signature may be present in the database based on a frequency of occurrence associated with the video signature. For example, the frequency of occurrence may comprise a quantity of times the video signature is associated with one or more content items.

As an example, the database may comprise a reference database comprising one or more unique reference video signatures used for identifying one or more content items. The video signature may be present in the reference database based on the frequency of occurrence being below a threshold. For example, the reference video signature may be determined as a unique reference video signature based on a determination that the frequency of occurrence of the reference video signature is below the threshold (e.g., below a threshold number of content items), and thus, included in the reference database.

As an example, the database may comprise a filter database comprising one or more frequent reference video signatures used for identifying one or more content items. The video signature may be present in the filter database based on the frequency of occurrence being above the threshold. For example, the reference video signature may be determined as a frequent reference video signature based on a determination that the frequency of occurrence of the reference video signature is above the threshold (e.g., above a threshold number of content items), and thus, included in the filter database.

At step 1906, a content item may be identified based on the video signature being present in the database. For example, the content item may be identified by the computing device (e.g., computing device 104, etc.) based on the video signature being present in the database. In an example, the content item may be identified based on a comparison of a reference video signature of one or more reference video signatures stored in the database. The reference video signature may be matched with the video signature to identify the content item. In an example, the video signature may be associated with metadata based on the video signature satisfying the threshold. The content item may be identified based on the metadata associated with the video signature and metadata associated with a reference video signature.

As an example, viewing history information may be determined. The viewing history information may be associated with a user device. The viewing history information may be updated based on the identification of the content item. In an example, a content recommendation may be determined based on the identification of the content item. For example, a content recommendation may be sent to, or caused at, the user device based on the identification of the content item. In an example, viewing history information considered by a content recommendation profile may be updated based on the identification of the content item.

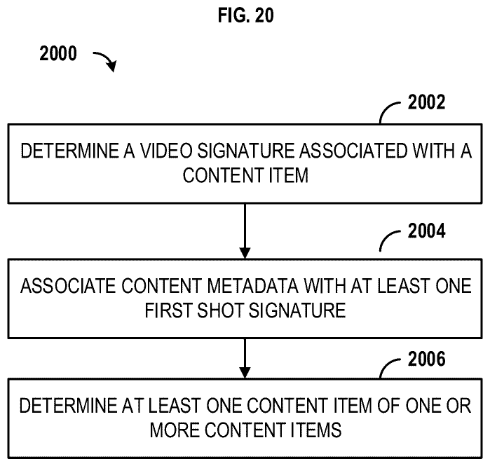

FIG. 20 shows an example method 2000 for filtering a database comprising one or more video signatures. Method 2000 may be implemented by the computing device 104. For example, method 2000 may be implemented by a computing device comprising one or more of a server, headend, or a cloud computing device. At step 2002, a video signature associated with a content item may be determined. For example, the video signature may be received by the computing device (e.g., computing device 104, etc.). The video signature may comprise one or more shot signatures and timing information. Each shot signature may comprise a color layout descriptor (CLD) of a frame of a content item associated with the video signature. The CLD may comprise data indicative of a spatial layout of the dominant colors on a grid superimposed on a frame of the content item. Each shot signature may be generated based on a shot change of the content item. For example, the shot change may comprise a content transition of the content item from a first camera perspective in a frame of the content item to a second camera perspective in a frame of the content item. The timing information may comprise information indicative of one or more of a time duration between a first shot change and a second shot change or a number of frames between a first shot change and a second shot change.

At step 2004, content metadata may be associated with at least one first shot signature of the one or more shot signatures based on a frequency of occurrence associated with the at least one shot signature. For example, the content metadata may be associated with at least one first shot signature by the computing device (e.g., computing device 104, etc.) based on a frequency of occurrence associated with the at least one first shot signature. For example, the frequency of occurrence may comprise a quantity of times the at least one first shot signature appears in the video signature. For example, the content metadata may be associated with at least one first shot signature based on the frequency of occurrence satisfying a frequency of occurrence threshold. For example, the at least one first shot signature may be determined as a frequent shot signature based on a determination that the frequency of occurrence of the at least one first shot signature satisfies the frequency of occurrence threshold (e.g., above a threshold number of appearances in the video signature), and thus, the at least one first shot signature may be associated with content metadata. In an example, at least one second shot signature may be determined as a unique shot signature based on a determination that the frequency of occurrence of the at least one second shot signature does not satisfy the frequency of occurrence threshold (e.g., below a threshold number of appearances in the video signature). The content metadata may comprise information indicative of one or more of a content identifier, a content type, or a content category.

At step 2006, at least one content item of the one or more content items may be determined based on a comparison between the content metadata associated with each first shot signature of the at least one first shot signature and content metadata associated with one or more content items satisfying a threshold. For example, the computing device (e.g., computing device 104, etc.) may determine the at least one content item based on the comparison between the content metadata associated with each first shot signature and the content metadata associated with the one or more content items satisfying the threshold. As an example, the at least one content item may be determined based on matching content metadata associated with a threshold number of first shot signatures with content metadata associated with the one or more content items. As an example, the at least one content item may be determined based on matching a threshold amount of information (e.g., content identifiers, content types, content categories, etc.) of the content metadata associated with each first shot signature of the at least one first shot signature with information (e.g., content identifiers, content types, content categories, etc.) of the content metadata associated with the one or more content items.

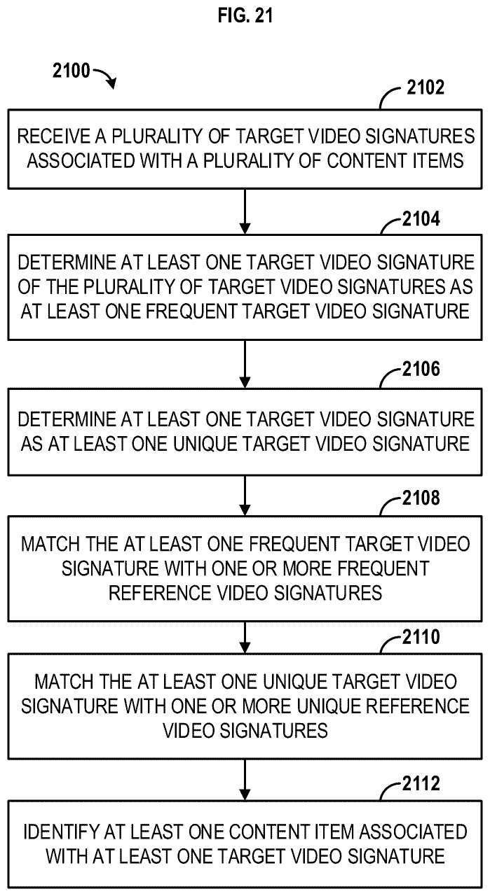

FIG. 21 shows an example method 2100 for filtering a database comprising one or more video signatures. Method 2100 may be implemented by the computing device 104. For example, method 2100 may be implemented by a computing device comprising one or more of a server, headend, or a cloud computing device. At step 2102, a plurality of target video signatures associated with a plurality of content items may be determined. For example, the plurality of target video signatures associated with the plurality of content items may be determined, or received, by the computing device (e.g., computing device 104, etc.) from a plurality of user devices. Each target video signature may comprise one or more shot signatures and timing information. Each shot signature may comprise a color layout descriptor (CLD) of a frame of a content item associated with the video signature. The CLD may comprise data indicative of a spatial layout of the dominant colors on a grid superimposed on a frame of the content item. Each shot signature may be generated based on a shot change of the content item. For example, the shot change may comprise a content transition of the content item from a first camera perspective in a frame of the content item to a second camera perspective in a frame of the content item. The timing information may comprise information indicative of one or more of a time duration between a first shot change and a second shot change or a number of frames between a first shot change and a second shot change.

At step 2104, at least one target video signature of the plurality of target video signatures may be determined as at least one frequent target video signature. For example, the at least one target video signature may be determined by the computing device (e.g., computing device 104, etc.) as at least one frequent target video signature. For example, the at least one target video signature may be determined as at least one frequent target video signature based on a frequency of occurrence associated with the at least one frequent target video signature. The frequency of occurrence may comprise information indicative of a quantity of times the at least video target video signature is associated with a plurality of content items. The at least one target video signature may be determined as a frequent target video signature based on a determination that the frequency of occurrence of the target video signature is above a threshold (e.g., above a threshold number of content items).

At step 2106, at least one target video signature may be determined as at least one unique target video signature. For example, the at least one target video signature may be determined by the computing device (e.g., computing device 104, etc.) as at least one unique target video signature. For example, the at least one target video signature may be determined as at least one unique target video signature based on a frequency of occurrence associated with the at least one frequent target video signature. The at least one target video signature may be determined as a unique target video signature based on a determination that the frequency of occurrence of the target video signature is below a threshold (e.g., below a threshold number of content items).

At step 2108, the at least one frequent target video signature may be matched with one or more frequent reference video signatures. For example, the at least one frequent target video signature may be matched with one or more frequent reference video signatures by the computing device (e.g., computing device 104, etc.). For example, one or more reference video signatures may be determined as one or more frequent reference signatures based on a determination that a frequency of occurrence associated with the one or more reference video signatures is above a threshold (e.g., above a threshold number of content items).

At step 2110, the at least one unique target video signature may be matched with one or more unique reference video signatures. For example, the at least one unique target video signature may be matched with one or more unique reference video signatures by the computing device (e.g., computing device 104, etc.). For example, one or more reference video signatures may be determined as one or more unique reference signatures based on a determination that a frequency of occurrence associated with the one or more reference video signatures is below a threshold (e.g., below a threshold number of content items).

At step 2112, at least one content item associated with at least one target video signature may be identified based on matching the at least one frequent target video signature with the one or more frequent reference video signatures and matching the at least one unique target video signature with the one or more unique reference video signatures. In an example, metadata may be associated with the one or more frequent video signatures. The metadata may comprise information indicative of one or more of a content identifier, a content type, or a content category. The metadata may be used to identify the content item, content type, or content category of the associated frequent reference video signature. For example, if the metadata identifies the associated frequent reference video as a content item associated with a program comprising a plurality of episodes, when a frequent reference video signature is matched with a frequent target video signature, the metadata may be used to determine that the target video signature is associated with the program. Thus, the matching process of the unique reference video signature and the unique target video signature may be simplified by comparing unique reference video signatures associated with the program with the unique target video signature. The at least one content item (e.g., episode of the program) may be determined based on matching a unique reference video signature associated with the program with the unique target video signature.

As an example, the at least one content item may be identified based on identifying one or more content items of the plurality of content items associated with the at least one target video signature. At least one content item may be filtered out of the matching process of the one or more content items based on content metadata associated with the at least one

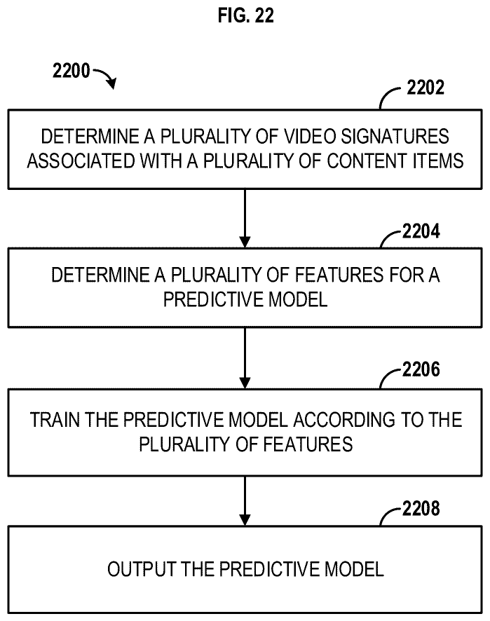

FIG. 22 shows an example method 2200 for filtering a database comprising one or more video signatures. Method 2200 may be implemented by the computing device 104. For example, method 2200 may be implemented by a computing device comprising one or more of a server, headend, or a cloud computing device. At step 2202, a plurality of video signatures associated with a plurality of content items may be determined. For example, the plurality of video signatures may be determined by the computing device (e.g., computing device 104). For example, the plurality of video signatures may be retrieved from a reference video signature database. Each video signature of the plurality of video signatures may comprise one or more shot signatures and timing information associated with the one or more shot signatures. The timing information may comprise information indicative of one or more of a time duration between a first shot change and a second shot change or a number of frames between a first shot change and a second shot change. Each video signature may be labeled according to a video signature frequency occurrence. The video signature frequency of occurrence may comprise a quantity of times the video signature is associated with the plurality of content items.

As an example, the plurality of video signatures may be determined based on baseline feature levels. For example, baseline feature levels may be determined for each group of video signatures of a plurality of groups of video signatures. The baseline feature levels for each group of video signatures may be labeled as at least one video signature frequency of occurrence of a plurality of video signature frequencies of occurrence. The plurality of video signatures may be generated based on the labeled baseline feature levels.

At step 2204, a plurality of features for a predictive model may be determined based on the plurality of video signatures. For example, the plurality of features may be determined by the computing device (e.g., computing device 104) based on the plurality of video signatures. The plurality of features may comprise a plurality of frequencies of occurrence associated with the plurality of video signatures. As an example, the plurality of video features for the predictive model may be determined based on features associated with a group of video signatures of the plurality of video signatures. For example, features present in a group of video signatures of the plurality of video signatures may be determined, from the plurality of video signatures, as a first set of candidate video signatures. Features of the first set of candidate video signatures that satisfy a first threshold value may be determined, from the plurality of video signatures, as a second set of candidate video signatures. Features of the second set of candidate video signatures that satisfy a second threshold value may be determined, from the plurality of video signatures, as a third set of candidate video signatures. The plurality of features may comprise the third set of candidate video signatures.

At step 2206, the predictive model may be trained based on a first portion of the plurality of video signatures. For example, the predictive model may be trained via the computing device (e.g., computing device 104) based on a first portion of the plurality of video signatures. For example, the first portion of the plurality of video signatures may be labeled according to one or more video signature frequencies of occurrence. The predictive model may be trained based on the labeled video signatures. As an example, training the predictive model based on the first portion of the plurality of video signatures may result in determining a feature signature indicative of at least one video signature frequency of occurrence of a plurality of video signature frequencies of occurrence. In an example, the predictive model may be tested based on a second portion of the plurality of video signatures. The second portion of the plurality of video signatures may comprise unlabeled video signatures. The testing may result in the predictive model correctly predicting the frequencies of occurrence associated with the plurality of video signatures.

At step 2208, the predictive model may be output. For example, the predictive model may be output by the computing device (e.g., computing device 104). The predictive model may be configured to output data indicative of a frequency of occurrence associated with a video signature.

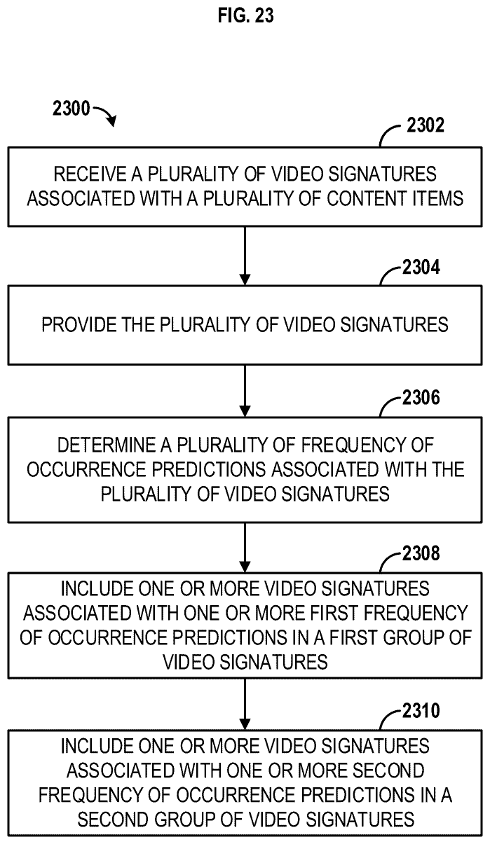

FIG. 23 shows an example method 2300 for filtering a database comprising one or more video signatures. Method 2300 may be implemented by the computing device 104. For example, method 2300 may be implemented by a computing device comprising one or more of a server, headend, or a cloud computing device. At step 2302, a plurality of video signatures associated with a plurality of content items may be received. For example, the plurality of video signatures may be received by the computing device (e.g., computing device 104). Each video signature of the plurality of video signatures may comprise one or more shot signatures and timing information associated with the one or more shot signatures. The timing information may comprise information indicative of one or more of a time duration between a first shot change and a second shot change or a number of frames between a first shot change and a second shot change. As an example, the plurality of video signatures may be received from a database or one or more user devices. At step 2204, the plurality of video signatures may be provided to a predictive model. For example, the plurality of video signatures may be provided to the predictive model by the computing device (e.g., computing device 104).

At step 2306, a plurality of frequency of occurrence predictions associated with the plurality of video signatures may be determined based on the predictive model. For example, the plurality of frequency of occurrence predictions associated with the plurality of video signatures may be determined by the computing device (e.g., computing device 104) based on the predictive model. Each frequency of occurrence prediction of the plurality of frequency of occurrence prediction may comprise a quantity of times each video signature of the plurality of video signatures is associated with the plurality of content items.

At step 2308, one or more video signatures associated with one or more first frequency of occurrence predictions of the plurality of frequency of occurrence predictions may be included in a first group of video signatures based on the one or more first frequency of occurrence predictions satisfying a threshold. For example, the computing device (e.g., computing device 104, etc.) may include the one or more video signatures in the first group of video signatures based on the one or more first frequency of occurrence predictions satisfying the threshold. As an example, the first group of video signatures may be stored in a reference database.

At step 2310, one or more video signatures associated with one or more second frequency of occurrence predictions of the plurality of frequency of occurrence predictions may be included in a second group of video signatures based on the one or more second frequency of prediction occurrences not satisfying the threshold. For example, the computing device (e.g., computing device 104, etc.) may include the one or more second video signatures associated with one or more second frequency of occurrence predictions in the second group of video signatures based on the one or more second frequency of prediction occurrences not satisfying the threshold. As an example, the second group of video signatures may be stored in a filter database. As an example, the one or more video signatures associated with the one or more second frequency of occurrence predictions may be excluded from the reference database based on the one or more second frequency of occurrence predictions not satisfying the threshold. As an example, the one or more video signatures associated with the one or more second frequency of occurrence predictions may be associated with metadata based on the one or more second frequency of occurrence predictions not satisfying the threshold.

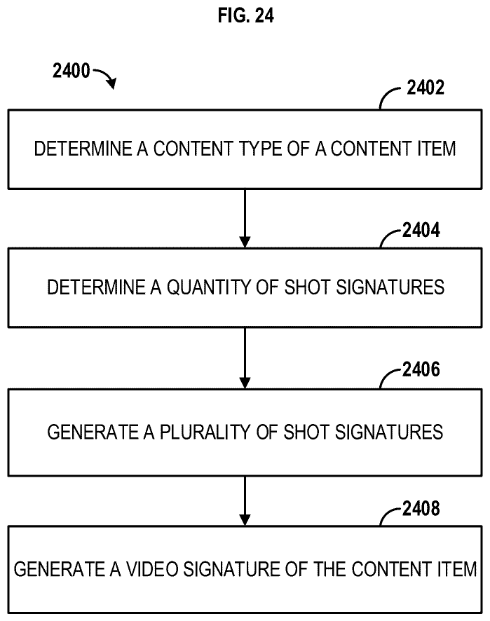

FIG. 24 shows an example method 2400 for determining an optimum number of shot signatures to use for generating a video signature. For example, single shot signature matching might not work if there are many different programs sharing the same shot signatures or different shot signatures with the same video signature. For example, movies produced by the same company may start with the same component intro. Thus, increasing the number of shot signatures used to generate a video signature may increase the uniqueness of the video signature. However, using too many shot signatures to generate the video signature may increase the latency, or time it takes, to generate the video signature. Method 2400 may be implemented by the devices 102, the network devices 116, the computing device 104, or any combination thereof. For example, method 2400 may be implemented by a device comprising one or more of a smart television, a computer, a smartphone, a laptop, a tablet, a set top box, server, headend, or a cloud computing device. At step 2402, a content type of the content item may be determined. For example, the content type of the content item may be determined by the device (e.g., devices 102, the network devices 116, the computing device 104, etc.). The content type may comprise one or more of an advertisement, a movie, linear content item, a video on demand, or a multi-episode television program.

At step 2404, a quantity of shot signatures may be determined based on the content type. For example, the quantity of shot signatures may be determined by the device (e.g., devices 102, the network devices 116, the computing device 104, etc.) based on the content type. For example, based on the content type indicating that the content item comprises an advertisement content, a quantity of at least ten shot signatures may be determined that need to be generated for the content item. Since an advertisement content may only span a small segment of time, increasing the number of shot signatures used to generate the video signature may increase the uniqueness, or level of uniqueness, associated with the video signature. In an example, a quantity of frequent shot signatures and a quantity of unique shot signatures may be determined based on a frequency of occurrence associated with each of the shot signatures. The frequency of occurrence may comprise a quantity of times each shot signature of the quantity of shot signatures appears in the content item or a quantity of times each shot signature of the quantity of shot signatures appears in one or more content items associated with the content type.

At step 2406, a plurality of shot signatures may be generated based on the quantity of shot signatures. For example, the plurality of shot signatures may be generated by the device (e.g., devices 102, the network devices 116, the computing device 104, etc.) based on the quantity of shot signatures. The plurality of shot signatures may be generated based on the quantity of frequent shot signatures and the quantity of unique shot signatures. For example, several frequent shot signatures and one unique shot signature may be generated based on the quantity of frequent shot signatures and the quantity of unique shot signatures.

At step 2408, a video signature of the content item may be generated based on the plurality of shot signatures. For example, the video signature of the content item may be generated by the device (e.g., devices 102, the network devices 116, the computing device 104, etc.) based on the plurality of shot signatures. The video signature may be generated based on the plurality of shot signatures in addition to timing information associated with the plurality of video signatures. For example, the timing information may comprise information indicative of one or more of a time duration between a first shot change and a second shot change or a number of frames between a first shot change and a second shot change. For example, if four shot signatures are used to generate the video signature, three timing information values (e.g., timing information values/durations between each shot signature) may be included in the video signature. In an example, additional shot signatures may be added to the video signature, wherein the overall performance (e.g., uniqueness) may be checked as each shot signature is added, or after every n number of shot signatures are added, to the video signature. Although increasing the number of shot signatures for generating the video signature may increase the uniqueness of the video signature, there is an increased risk that the final video signature may include shot signatures that may overlap the boundaries between two different content items, or two pieces of content items, such as between an advertisement content and a program content. If the performance indicates that a shot signature overlaps with a boundary of an additional content item, the shot signature, and its associated timing information, may be removed from the video signature and the video signature may be generated based on the preceding shot signatures and the timing information associated with the preceding shot signatures. In an example, adjacent video signatures may share some common shot signatures. For example, if four shot signatures are used to generate the video signature, three shot signatures (or less) can be shared with the next video signature. This may increase the chance that a relatively long video signature contains only one piece of content (e.g., advertisement or program) without knowing exactly where the content boundary is located.

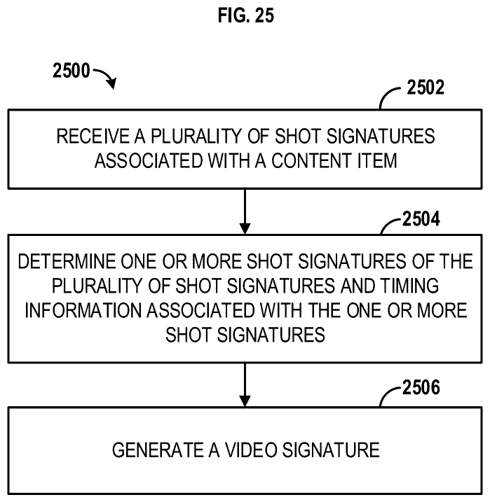

FIG. 25 shows an example method 2500 for determining an optimum number of shot signatures to use for generating a video signature. Method 2500 may be implemented by the devices 102, the network devices 116, the computing device 104, or any combination thereof. For example, method 2500 may be implemented by a device comprising one or more of a smart television, a computer, a smartphone, a laptop, a tablet, a set top box, server, headend, or a cloud computing device. At step 2502, a plurality of shot signatures associated with a content item may be received. For example, the plurality of shot signatures associated with the content item may be received by the device (e.g., devices 102, the network devices 116, the computing device 104, etc.). For example, the plurality of shot signatures may be generated from one or more frames of the content item.

At step 2504, one or more shot signatures of the plurality of shot signatures and timing information associated with the one or more shot signatures may be determined based on information associated with each shot signature of the plurality of shot signatures. For example, the one or more shot signatures and the timing information may be determined by the device (e.g., devices 102, the network devices 116, the computing device 104, etc.) based on the information associated with each shot signature. The timing information may comprise information indicative of one or more of a time duration between a first shot change and a second shot change or a number of frames between a first shot change and a second shot change. As an example, the information associated with each shot signature may comprise information indicative of a measure of uniqueness of each shot signature. As an example, the information associated with each shot signature may comprise metadata. For example, the metadata may comprise information indicative of one or more of a content identifier, a content type, or a content category. As an example, the information associated with each shot signature may be determined based on a frequency of occurrence associated with each shot signature. The frequency of occurrence associated with each shot signature may comprise a quantity of times each shot signature is associated with the content item.

At step 2506, a video signature may be generated based on the one or more signatures and the timing information. For example, the video signature may be generated by the device (e.g., devices 102, the network devices 116, the computing device 104, etc.) based on the one or more signatures and the timing information.

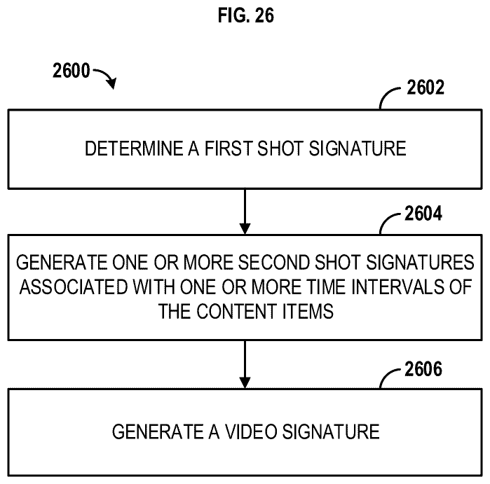

FIG. 26 shows an example method 2600 for determining an optimum number of shot signatures to use for generating a video signature. Method 2600 may be implemented by the devices 102, the network devices 116, the computing device 104, or any combination thereof. For example, method 2600 may be implemented by a device comprising one or more of a smart television, a computer, a smartphone, a laptop, a tablet, a set top box, server, headend, or a cloud computing device. At step 2602, a first shot signature may be determined based on a shot change associated with a content item. For example, the first shot signature may be determined by the device (e.g., devices 102, the network devices 116, the computing device 104, etc.) based on a shot change associated with a content item. A shot change may be determined based on a content transition of the content item from a first camera perspective in a frame of the content item to a second camera perspective in a frame of the content item. In an example, the first shot signature may be generated based on a frame of the content item. For example, a first shot/frame of the content item may be used to generate the first shot signature.

At step 2604, one or more second shot signatures associated with one or more time intervals of the content item may be generated based on a failure to detect a shot change within a time duration. For example, the one or more second shot signatures associated with the one or more time intervals of the content item may be generated by the device (e.g., devices 102, the network devices 116, the computing device 104, etc.) based on the failure to detect the shot change within the time duration. The one or more second shot signatures may be generated based on one or more frames of the content item associated with the one or more time intervals. For example, each second shot signature of the one or more second shot signatures may be generated for each time interval of the one or more time intervals. For example, one or more second shot signatures may be associated with one or more groups of frames of the content item associated with the one or more time intervals. For example, if a first shot is longer than 10 seconds, a smaller time interval, such as two-second time intervals, may be used to generate the one or more second shot signatures. For example, each second shot signature of the one or more second shot signatures may be generated for each two-second time interval. The one or more time intervals may be associated with a time interval subsequent to a time interval associated with the first shot signature. In an example, a frame representation may be generated for each frame of the content item, wherein the failure to detect the shot change may be based on failing to detect a shot change from the one or more frame representations.

At step 2606, a video signature may be generated based on the first shot signature and the one or more second shot signatures. For example, the video signature may be generated by the device (e.g., devices 102, the network devices 116, the computing device 104, etc.) based on the first shot signature and the one or more second shot signatures. In an example, the video signature may further comprise timing information indicative of the one or more time intervals.

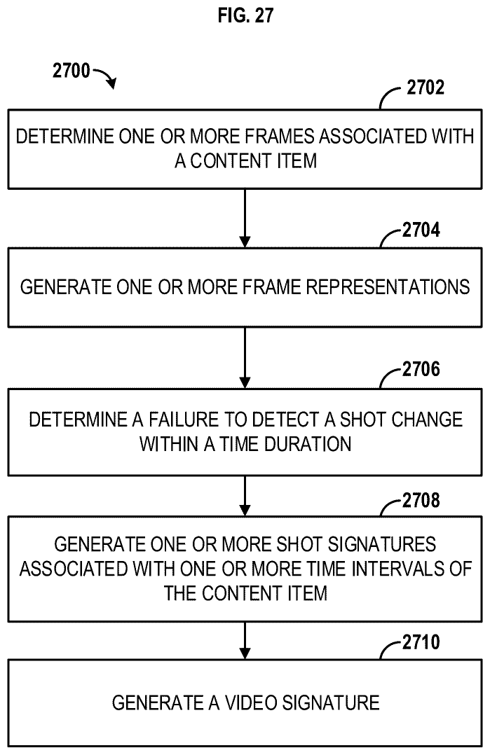

FIG. 27 shows an example method 2700 for determining an optimum number of shot signatures to use for generating a video signature. Method 2700 may be implemented by the devices 102, the network devices 116, the computing device 104, or any combination thereof. For example, method 2700 may be implemented by a device comprising one or more of a smart television, a computer, a smartphone, a laptop, a tablet, a set top box, server, headend, or a cloud computing device. At step 2702, one or more frames associated with a content item may be determined. For example, the one or more frames of the content item may be determined by the device (e.g., devices 102, the network devices 116, the computing device 104, etc.).

At step 2704, one or more frame representations may be generated based on each frame of the one or more frames. For example, the one or more frame representations may be generated by the device (e.g., devices 102, the network devices 116, the computing device 104, etc.) based on each frame. Each frame representation may comprise a frame block descriptor of a frame of the content item. For example, a plurality of areas of each frame associated with the content item may be determined. A pixel average for each area of the plurality of areas of each frame may be determined. Each frame representation may be generated based on a pixel average associated with each area of the plurality of areas of each frame of the content item.

At step 2706, a failure to detect a shot change within a time duration may be determined based on the one or more frame representations. For example, the failure to detect the shot change within the time duration may be determined by the device (e.g., devices 102, the network devices 116, the computing device 104, etc.) based on the one or more frame representations. For example, the content item may not comprise a shot change within 20 seconds of a first shot/frame of the content item. Thus, a shot change may not be detected within 20 seconds of the first shot/frame.

At step 2708, one or more shot signatures associated with one or more time intervals of the content item may be generated based on the failure to detect the shot change within the time duration. For example, the one or more shot signatures associated with one or more time intervals of the content item may be generated by the device (e.g., devices 102, the network devices 116, the computing device 104, etc.) based on the failure to detect the shot change within the time duration. For example, if a shot change is not detected within 20 seconds of a first shot/frame of the content item, one or more shot signatures of the content item may be generated based on smaller three-second time intervals of the content item.

At step 2710, a video signature may be generated based on the one or more shot signatures. For example, the video signature may be generated by the device (e.g., devices 102, the network devices 116, the computing device 104, etc.) based on the one or more shot signatures. In an example, the video signature may comprise timing information indicative of the one or more time intervals.

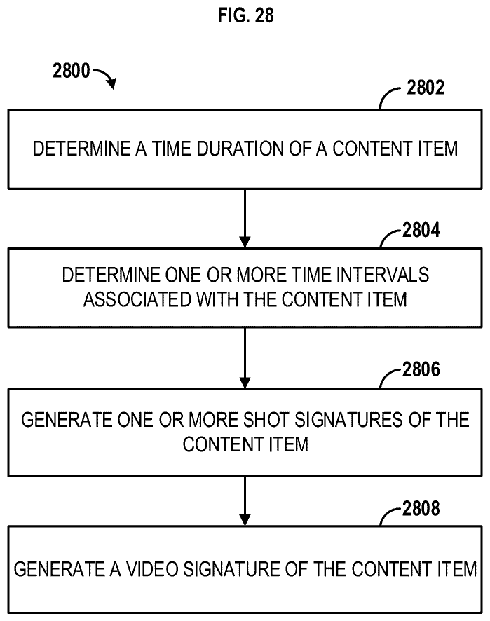

FIG. 28 shows an example method 2800 for determining an optimum number of shot signatures to use for generating a video signature. Method 2800 may be implemented by the devices 102, the network devices 116, the computing device 104, or any combination thereof. For example, method 2800 may be implemented by a device comprising one or more of a smart television, a computer, a smartphone, a laptop, a tablet, a set top box, server, headend, or a cloud computing device. At step 2802, a time duration of a content item may be determined. For example, the time duration of the content item may be determined by the device (e.g., devices 102, the network devices 116, the computing device 104, etc.). For example, a total length of time of the content item may be determined. For example, a content item may comprise a time duration of 30 minutes, 45 minutes, 190 minutes, etc.

At step 2804, one or more time intervals associated with the content item may be determined based on the time duration. For example, the one or more time intervals associated with the content item may be determined by the device (e.g., devices 102, the network devices 116, the computing device 104, etc.) based on the time duration. For example, the content item may be split into 10 equal time intervals of the total length of time. For example, a 30-second content item may be split into 10 three-second time intervals.

At step 2806, one or more shot signatures of the content item may be generated based on the one or more time intervals. For example, the one or more shot signatures of the content item may be generated by the device (e.g., devices 102, the network devices 116, the computing device 104, etc.) based on the one or more time intervals. Each shot signature of the one or more shot signatures may comprise a color layout descriptor. The CLD may comprise data indicative of a spatial layout of the dominant colors of a grid superimposed on a frame of the content item. Each CLD may be generated based on applying a cosine transformation to each frame.

At step 2808, a video signature of the content item may be generated based on the one or more shot signatures. For example, the video signature of the content item may be generated by the device (e.g., devices 102, the network devices 116, the computing device 104, etc.) based on the one or more shot signatures. In an example, the video signature may further comprise timing information indicative of the one or more time intervals.

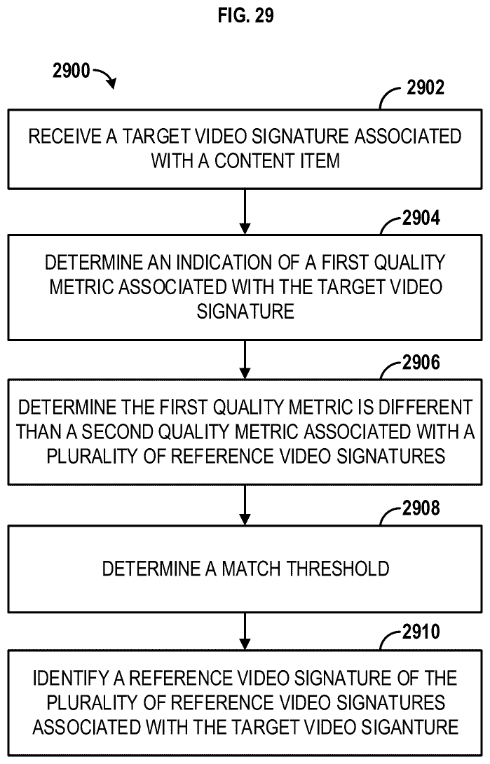

FIG. 29 shows an example method 2900 for comparing video signatures based on differences in content quality of a content item associated with a target video signature and a reference video signature. Method 2900 may be implemented by the computing device 104. For example, method 2900 may be implemented by a computing device comprising one or more of a server, headend, or a cloud computing device. At step 2902, a target video signature associated with a content item may be received. For example, the target video signature may be received by the computing device (e.g., computing device 104, etc.) from a user device. The target video signature may comprise one or more target shot signatures.

At step 2904, an indication of a first quality metric associated with the target video signature may be determined. For example, the indication may be determined by the computing device (e.g., computing device 104, etc.). The first quality metric may comprise one or more of an aspect ratio, a resolution, or a frame rate. For example, a user device may generate the target video signature from a content item output in standard definition while a reference video signature may be generated from a content item stored, in a high definition format of the content item, in a database of the computing device.

At step 2906, the first quality metric may be determined to be different than a second quality metric associated with a plurality of reference video signatures. For example, the first quality metric may be determined by the computing device (e.g., computing device 104, etc.) to be different than the second quality metric associated with the plurality of reference video signatures. The plurality of reference video signatures may comprise one or more reference shot signatures. For example, the plurality of reference video signatures may be generated based on a plurality of content items stored in a high definition format in a database of the computing device. Thus, there may be slight differences between the target video signature and the plurality of reference video signatures based on the differences in quality metrics of the content items used to generate the video signatures.

At step 2908, a match threshold may be determined based on the difference between the first quality metric and the second quality metric. For example, the match threshold may be determine by the computing device (e.g., computing device 104, etc.) based on the difference between the first quality metric and the second quality metric. As an example, the match threshold may be adjusted based on the difference between the first quality metric and the second quality metric. For example, the match threshold (e.g., an adjustable tolerance) may be used to determine how closely the target video signature needs to match at least one of the plurality of reference video signatures in order to determine a content item associated with the target video signature.

At step 2910, a reference video signature of the plurality of reference video signatures associated with the target video signature may be identified based on the adjusted match threshold. For example, the reference video signature may be identified by the computing device (e.g., computing device 104, etc.) based on the adjusted match threshold. In an example, the reference video signature may be identified based on a comparison of the target video signature and the plurality of reference video signatures satisfying the adjusted match threshold. For example, the reference video signature may be identified based on a match between the target video signature and a reference video signature of the plurality of reference video signatures that satisfies the match threshold.

In an example, the match threshold may be used to determine how closely one or more shot signatures of the target video signature needs to match one or more shot signatures of a reference video signature of the plurality of reference video signatures in order to determine a content item associated with the target video signature. For example, one or more shot signatures of the target video signature may have only slight differences with one or more shot signatures of the reference video signature. In addition, the time durations the target video signature and the reference video signature may match each other. The slight differences between the one or more shot signatures may be determined to be within the match threshold, and thus, the target video signature may be determined to match the reference video signature, especially since the time durations of the target video signature and the reference video signature match each other, for example.

In an example, the match threshold may be used to determine how closely timing information of the target video signature needs to match timing information of the reference video signature in order to determine the content item associated with the target video signature. For example, one or more time durations may of the target video signature may only differ by one second in comparison to one or more time durations of the reference video signature. In addition, the shot signatures of the target video signature and the shot signatures of the reference video signatures may match each other. For example, the match threshold may comprise a timing offset (e.g., timing tolerance) comprising a tolerance of plus or minus three seconds. Since the one or more time durations of the target video signatures are within the match threshold, the target video signature may be determined to match the reference video signature, especially since the shot signatures of the target video signature and the reference video signature match each other, for example.

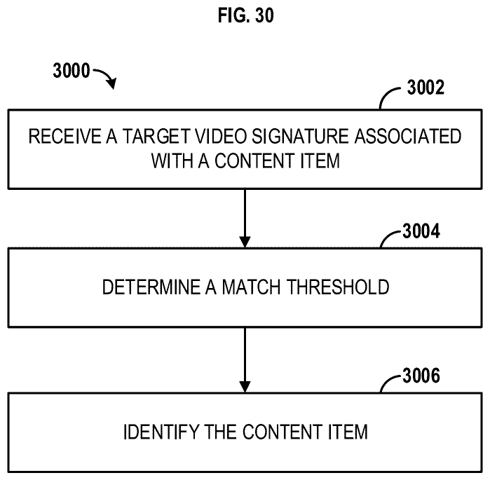

FIG. 30 shows an example method 3000 for comparing video signatures based on differences in content quality of a content item associated with a target video signature and a reference video signature. Method 3000 may be implemented by the computing device 104. For example, method 3000 may be implemented by a computing device comprising one or more of a server, headend, or a cloud computing device. At step 3002, a target video signature associated with a content item may be received. For example, the target video signature may be received by the computing device (e.g., computing device 104, etc.). The target video signature may comprise one or more target shot signatures.

At step 3004, a match threshold may be determined based on an indication of a first quality metric associated with the target video signature. For example, the match threshold may be determined by the computing device (e.g., computing device 104, etc.) based on the indication of the first quality metric. The first quality metric may comprise one or more of an aspect ratio, a resolution, or a frame rate. For example, a user device may generate the target video signature from a content item output in standard definition while a reference video signature may be generated from a content item stored, in a high definition format of the content item, in a database of the computing device. The match threshold (e.g., an adjustable tolerance) may be used to determine how closely the target video signature needs to match at least one of the plurality of reference video signatures in order to determine a content item associated with the target video signature. In an example, the match threshold may be determined based on a difference between the first quality metric and a second quality metric associated with the plurality of reference video signatures. In an example, the match threshold may be adjusted based on a difference between the first quality metric and a second quality metric associated with the plurality of reference video signatures.

At step 3006, the content item may be identified based on a comparison of the target video signature and a plurality of reference video signatures satisfying the match threshold. For example, the content item may be identified by the computing device (e.g., computing device 104, etc.) based on the comparison of the target video signature and the plurality of reference video signatures satisfying the match threshold. The plurality of reference video signatures may comprise one or more reference shot signatures. In an example, the reference video signature may be identified based on a comparison of the target video signature and the plurality of reference video signatures satisfying the adjusted match threshold. For example, the reference video signature may be identified based on a match between the target video signature and a reference video signature of the plurality of reference video signatures that satisfies the match threshold.

In an example, the match threshold may be used to determine how closely one or more shot signatures of the target video signature needs to match one or more shot signatures of a reference video signature of the plurality of reference video signatures in order to determine a content item associated with the target video signature. For example, one or more shot signatures of the target video signature may have only slight differences with one or more shot signatures of the reference video signature. In addition, the time durations the target video signature and the reference video signature may match each other. The slight differences between the one or more shot signatures may be determined to be within the match threshold, and thus, the target video signature may be determined to match the reference video signature, especially since the time durations of the target video signature and the reference video signature match each other, for example.

In an example, the match threshold may be used to determine how closely timing information of the target video signature needs to match timing information of the reference video signature in order to determine the content item associated with the target video signature. For example, one or more time durations may of the target video signature may only differ by one second in comparison to one or more time durations of the reference video signature. In addition, the shot signatures of the target video signature and the shot signatures of the reference video signatures may match each other. For example, the match threshold may comprise a timing offset (e.g., timing tolerance) comprising a tolerance of plus or minus three seconds. Since the one or more time durations of the target video signatures are within the match threshold, the target video signature may be determined to match the reference video signature, especially since the shot signatures of the target video signature and the reference video signature match each other, for example.

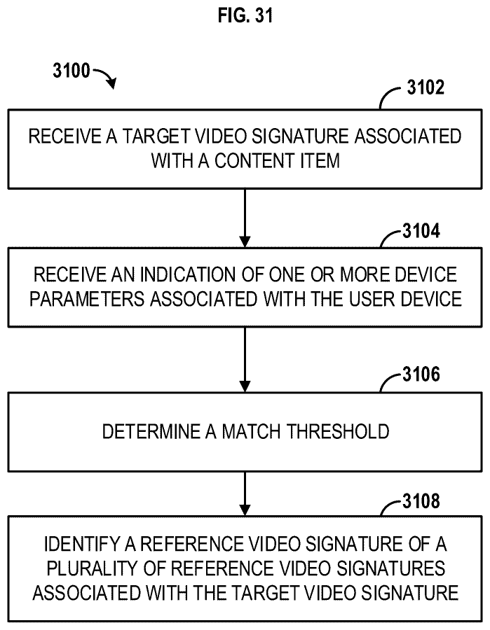

FIG. 31 shows an example method 3100 for comparing video signatures based on differences in content quality of a content item associated with a target video signature and a reference video signature. Method 3100 may be implemented by the computing device 104. For example, method 3100 may be implemented by a computing device comprising one or more of a server, headend, or a cloud computing device. At step 3102, a target video signature associated with a content item may be received. For example, the target video signature may be received by the computing device (e.g., computing device 104, etc.) from a user device. The target video signature may comprise one or more target shot signatures.

At step 3104, an indication of one or more device parameters associated with a user device may be determined. For example, the indication of the one or more device parameters associated with the user device may be determined by the computing device (e.g., computing device 104, etc.). The one or more device parameters may comprise one or more of network conditions or device capabilities. For example, network bandwidth conditions or device capabilities may affect the quality of the content item output by the user device. In an example, as a result of low network bandwidth conditions, a standard definition version of the content item may be processed in order to generate the target video signature. In an example, the user device may only be capable of processing a low resolution, or a low frame rate, version of the content resulting in the target video signature being generated from a low quality content item.

At step 3106, a match threshold may be determined based on the one or more device parameters. For example, the match threshold may be determined by the computing device (e.g., computing device 104, etc.) based on the one or more device parameters. For example, the match threshold may be determined based on the one or more device parameters in order to determine how closely a target video signature needs to match a reference video signature to determine the content item associated with the target video signature. As an example, the match threshold may be adjusted based on the difference between the first quality metric and the second quality metric.

At step 3108, a reference video signature of a plurality of reference video signatures associated with the target video signature may be identified based on the adjusted match threshold. For example, the reference video signature may be identified by the computing device (e.g., computing device 104, etc.) based on the adjusted match threshold. In an example, the content item may be identified based on the identification of the reference video signature.

In an example, the match threshold may be used to determine how closely one or more shot signatures of the target video signature needs to match one or more shot signatures of a reference video signature of the plurality of reference video signatures in order to determine a content item associated with the target video signature. For example, one or more shot signatures of the target video signature may have only slight differences with one or more shot signatures of the reference video signature. In addition, the time durations the target video signature and the reference video signature may match each other. The slight differences between the one or more shot signatures may be determined to be within the match threshold, and thus, the target video signature may be determined to match the reference video signature, especially since the time durations of the target video signature and the reference video signature match each other, for example.

In an example, the match threshold may be used to determine how closely timing information of the target video signature needs to match timing information of the reference video signature in order to determine the content item associated with the target video signature. For example, one or more time durations may of the target video signature may only differ by one second in comparison to one or more time durations of the reference video signature. In addition, the shot signatures of the target video signature and the shot signatures of the reference video signatures may match each other. For example, the match threshold may comprise a timing offset (e.g., timing tolerance) comprising a tolerance of plus or minus three seconds. Since the one or more time durations of the target video signatures are within the match threshold, the target video signature may be determined to match the reference video signature, especially since the shot signatures of the target video signature and the reference video signature match each other, for example.

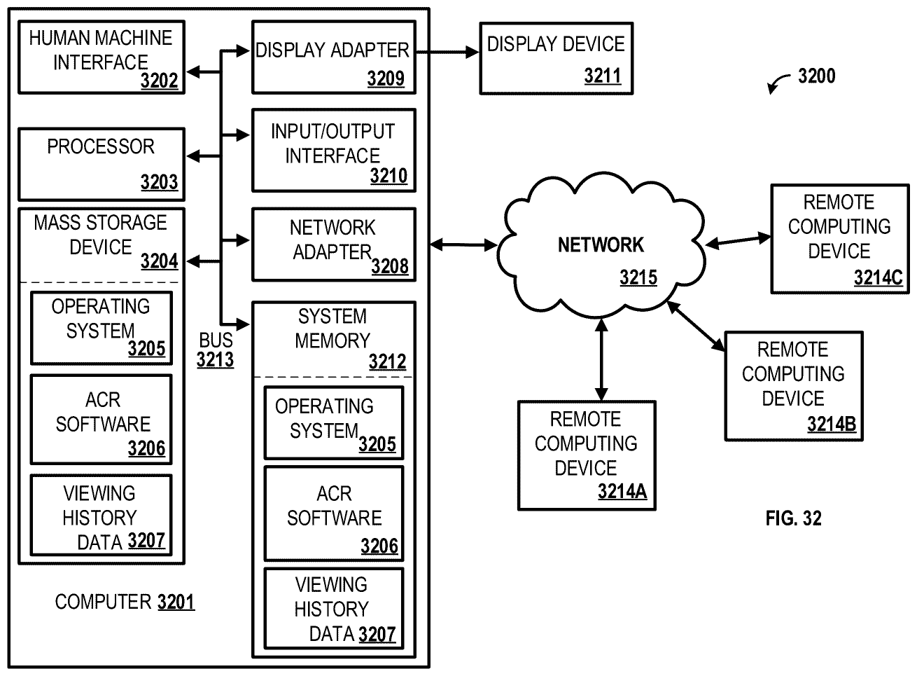

The methods and systems can be implemented on a computer 3201 as illustrated in FIG. 32 and described below. By way of example, computing device 104, device 102, and/or the network device 116 of FIG. 1 can be a computer 3601 as illustrated in FIG. 32. Similarly, the methods and systems disclosed can utilize one or more computers to perform one or more functions in one or more locations. FIG. 32 is a block diagram illustrating an example operating environment 3600 for performing the disclosed methods. This example operating environment 3200 is only an example of an operating environment and is not intended to suggest any limitation as to the scope of use or functionality of operating environment architecture. Neither should the operating environment 3200 be interpreted as having any dependency or requirement relating to any one or combination of components illustrated in the example operating environment 3200.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 3201. The computer 3201 can comprise one or more components, such as one or more processors 3203, a system memory 3212, and a bus 3213 that couples various components of the computer 3201 comprising the one or more processors 3203 to the system memory 3212. The system can utilize parallel computing.

The bus 3213 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 3213, and all buses specified in this description can also be implemented over a wired or wireless network connection and one or more of the components of the computer 3201, such as the one or more processors 3203, a mass storage device 3204, an operating system 3205, ACR software 3206, viewing history data 3207, a network adapter 3208, the system memory 3212, an Input/Output Interface 3210, a display adapter 3209, a display device 3211, and a human machine interface 3202, can be contained within one or more remote computing devices 3214A-3214C at physically separate locations, connected through buses of this form, in effect implementing a fully distributed system.

The computer 3201 typically comprises a variety of computer readable media. Examples of readable media can be any available media that is accessible by the computer 3601 and comprises, for example and not meant to be limiting, both volatile and non-volatile media, removable and non-removable media. The system memory 3212 can comprise computer readable media in the form of volatile memory, such as random access memory (RAM), and/or non-volatile memory, such as read only memory (ROM). The system memory 3212 typically can comprise data such as the viewing history data 3207 and/or program modules such as the operating system 3205 and the ACR software 3206 that are accessible to and/or are operated on by the one or more processors 3203.

In another aspect, the computer 3201 can also comprise other removable/non-removable, volatile/non-volatile computer storage media. The mass storage device 3204 can provide non-volatile storage of computer code, computer readable instructions, data structures, program modules, and other data for the computer 3201. For example, the mass storage device 3204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 3204, such as, by way of example, the operating system 3205 and the ACR software 3606. One or more of the operating system 3205 and the ACR software 3206 (or some combination thereof) can comprise elements of the programming and the ACR software 3606. The viewing history data 3207 can also be stored on the mass storage device 3204. The viewing history data 3207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 3215.

In another aspect, the user can enter commands and information into the computer 3201 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 3203 via the human machine interface 3202 that is coupled to the bus 3213, but can be connected by other interface and bus structures, such as a parallel port, game port, an IEEE 1394 Port (also known as a Firewire port), a serial port, a network adapter 3208, and/or a universal serial bus (USB).

In yet another aspect, the display device 3211 can also be connected to the bus 3213 via an interface, such as the display adapter 3209. It is contemplated that the computer 3201 can have more than one display adapter 3209 and the computer 3201 can have more than one display device 3211. For example, the display device 3211 can be a monitor, an LCD (Liquid Crystal Display), light emitting diode (LED) display, television, smart lens, smart glass, and/or a projector. In addition to the display device 3211, other output peripheral devices can comprise components such as speakers (not shown) and a printer (not shown) which can be connected to the computer 3201 via an Input/Output Interface 3210. Any step and/or result of the methods can be output in any form to an output device. Such output can be any form of visual representation, comprising, but not limited to, textual, graphical, animation, audio, tactile, and the like. The display device 3211 and the computer 3201 can be part of one device, or separate devices.

The computer 3201 can operate in a networked environment using logical connections to one or more remote computing devices 3214A-3214C. By way of example, a remote computing device 3214A-3214C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 3201 and a remote computing device 3214A-3214C can be made via a network 3215, such as a local area network (LAN) and/or a general wide area network (WAN). Such network connections can be through the network adapter 3208. The network adapter 3208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 3205 are illustrated herein as discrete blocks, although it is recognized that such programs and components can reside at various times in different storage components of the computing device 3201, and are executed by the one or more processors 3203 of the computer 3201. An implementation of the ACR software 3206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
determining, by a device, one or more frames associated with a content item;
determining, based on the one or more frames, timing information associated with one or more shot changes of the content item;
generating, based on the one or more shot changes, one or more shot signatures; and
generating, based on the one or more shot signatures and the timing information, a video signature associated with the content item.

2. The method of claim 1, wherein the timing information comprises one or more of a time duration between a first shot change and a second shot change or a number of frames between a first shot change and a second shot change.

3. The method of claim 1, wherein each shot signature of the one or more shot signatures comprises a color layout descriptor associated with a frame of the content item.

4. The method of claim 1, wherein determining, based on the one or more frames, the timing information associated with the one or more shot changes of the content item comprises:
determining, based on a difference between every two adjacent frames of the one or more frames satisfying a threshold, the one or more shot changes; and
determining, based on the one or more shot changes, the timing information associated with the one or more shot changes.

5. The method of claim 1, wherein generating, based on the one or more shot changes, the one or more shot signatures comprises:
determining, based on the one or more shot changes, one or more groups of frames associated with the one or more shot changes; and
generating, based on a first frame of each group of frames of the one or more groups of frames, the one or more shot signatures.

6. The method of claim 1, further comprising:
sending the video signature; and
receiving, based on the video signature, one or more of viewing history information or a content recommendation.

7. The method of claim 1, further comprising:
receiving, from one or more user devices, one or more target video signatures associated with one or more content items; and
identifying, based on the one or more target video signatures and the video signature, the content item.

8. The method of claim 7, further comprising:
determining viewing history information; and
updating the viewing history information with the identification of the content item.

9. A method comprising:
determining, by a device, one or more frames associated a content item;
determining, based on the one or more frames, one or more shot changes of the content item;
generating, based on the one or more shot changes, one or more shot signatures; and
generating, based on the one or more shot signatures, a video signature associated with the content item.

10. The method of claim 9, wherein each shot signature of the one or more shot signatures comprises a color layout descriptor associated with a frame representation.

11. The method of claim 9, wherein determining, based on the one or more frames, the one or more shot changes of the content item comprises determining, based on a difference between every two adjacent frames of the one or more frames satisfying a threshold, the one or more shot changes.

12. The method of claim 9, wherein generating, based on the one or more shot changes, the one or more shot signatures comprises:
determining, based on the one or more shot changes, one or more groups of frames associated with the one or more shot changes; and
generating, based on a first frame of each group of frames of the one or more groups of frames, the one or more shot signatures.

13. The method of claim 9, further comprising:
sending the video signature; and
receiving, based on the video signature, one or more of viewing history information or a content recommendation.

14. The method of claim 9, further comprising:
receiving, from one or more user devices, one or more target video signatures associated with one or more content items; and
identifying, based on the one or more target video signatures and the video signature, the content item.

15. The method of claim 14, further comprising:
determining viewing history information; and
updating the viewing history information with the identification of the content item.

16. A method comprising:
receiving, by a computing device from one or more user devices, one or more target video signatures associated with one or more content items;
determining one or more reference video signatures;
identifying, based on the one or more target video signatures and the one or more reference video signatures, the one or more content items; and
determining, based on the identification of the one or more content items, viewing history information.

17. The method of claim 16, wherein each target video signature of the one or more target video signatures comprise one or more target shot signatures and timing information associated with the one or more target shot signatures, and wherein each reference video signature of the one or more reference video signatures comprise one or more reference shot signatures and timing information associated with the one or more reference shot signatures.

18. The method of claim 16, wherein identifying, based on the one or more target video signatures and the one or more reference video signatures, the one or more content items comprises identifying, based on comparing the one or more target video signatures and the one or more reference video signatures, the one or more content items.

19. The method of claim 16, wherein determining, based on the identification of the one or more content items, the viewing history information comprises updating, based on the identification of the one or more content items, a viewing count.

20. The method of claim 16, further comprising one or more of: sending, based on the identification of the one or more content items, a content recommendation; or updating, based on the identification of the one or more content items, viewing history information considered by a content recommendation user profile.
